(19) United States
(12) Patent Application Publication
(10) Pub. No.: US 2011/0295711 A1
(43) Pub. Date: Dec. 1, 2011

(54) Apparel Fit Advisory Service

(76) Inventor: Rouben Mazmanyan, Moscow (RU)

(21) Appl. No.: 13/118,428

(22) Filed: May 29, 2011

Related U.S. Application Data
(60) Provisional application No. 61/350,331, filed on Jun. 1, 2010.

(51) Int. Cl. G06Q 30/00

(52) U.S. Cl. 705/26.7

(57) ABSTRACT

A data processing method determines an appropriate size of a selected apparel for an individual based on the individual's fit indicators characterizing the fit of apparels to the individual. The fit indicators factor in the individual's body profile and fit preferences. The method employs data on fit indicators associated with other individuals, where these fit indicators are for apparels that are at least of the same type and style as the apparel in question. In addition, at least one fit indicator associated with the other individuals is related to a certain size of the apparel in question.

### FIELD OF THE INVENTION

The invention relates to methods of data processing for determining an apparel size for an individual depending on the individual's body profile and apparel fit preferences.

### BACKGROUND OF THE INVENTION

Individuals that do not have opportunity to try on an apparel when purchasing it, such as those ordering an item of apparel through the Internet, have to select an appropriate size of the apparel based on apparel standard sizing charts that determine correlation between the size of an apparel and a limited set of body measurements of individuals. These charts neither provide complete information on apparel measurements, nor do they take into account possible differences in buyers' individual fit preferences. This is one of the major reasons why the individuals having specific fit preferences and specific body anatomy cannot remotely select appropriate apparel size, which often leads to apparel return.

Moreover, the size indicated on the garment tag may not match the same size in the sizing chart. For example, the size on the tag of an apparel item could be “XS” but in reality it corresponds with the “S” size in the sizing chart or may not correspond with any of sizes in the sizing chart. This happens because there is no apparel sizing standard comprising apparel size and corresponding apparel measurements. The existing apparel size standards differ from each other because they were created based on groups of individuals with average anthropometrical data and average style and fit preferences typical for certain groups of inhabitants of each country or regions of the world. Many apparel manufacturers do not follow these standards since they have their own concepts of the structure of their potential buyers based on which they determine as the number of sizes of an apparel in their product lines as well as the specifications of articles, which are specific for each size of apparel. As a consequence, individuals having specific body anatomy and specific preferences in fit of apparel cannot determine appropriate size of an apparel when purchasing it using standard sizing charts, which frequently causes return of purchased apparel back to sellers in situations where buyers do not have the opportunity to try apparel on before buying it.

### SUMMARY OF THE INVENTION

One aspect of the present invention is that it provides methods to fit a selected apparel to an individual by factoring in the individual's fit preferences and specific body anatomy using actual fit indicators (fit assessments) associated with the individual and with other individuals related to apparels of the same style and type as the selected apparel, with possible employment of anthropometric parameters of the individuals and characteristics related to the apparels. The usage of the fit assessments may be realized through means of comparing the fit assessments associated with the individual with the respective fit assessments associated with the other individuals, which may further employ a comparison within the fit assessments associated with the other individuals and a comparison within the fit assessments associated with each of the individuals. Another aspect of the invention is that a comparing operation may further comprise defining for all the individuals, with whom associated fit assessments are used in the comparing, overlap pairs of individuals having associated fit assessments related to the same apparels, and a following comparison between fit assessments for the defined overlap pairs. Alternatively, a comparing operation may further comprise defining for all the individuals, with whom associated fit assessments are used in the comparison, overlap pairs of designations and sizes having related fit assessments associated with different individuals, and a following comparison between fit assessments for the defined overlap pairs. Any comparison may further involve determination of similarities and functional relations between the comparing items. Based on the results of the comparison operation, fit indicators related to the selected apparel of various sizes may be predicted for the individual in order to completely characterize a fit of the selected apparel for one or more sizes, and the subsequent comparison of the predicted fit indicators with the fit indicators compliant with the proper fit of apparels to individuals and/or a subsequent comparison of the predicted fit indicators with each other may be applied to determine the recommended size or several recommended sizes of the selected apparel for the individual.

Yet another aspect of the invention is that an additional comparison within the fit assessments predicted for the individuals and/or a comparison of the fit assessments predicted for the individual with the respective fit assessments associated with other individuals may entail predicting fit assessments for the individual for the missing sizes, for which the fit assessments were not initially predicted, resulting in associating with each of the considered sizes the respective one or more predicted fit assessments. Detailed recommendations comprising a grade of the fit of each element of the selected apparel to the individual may be provided for each of the recommended size of apparel.

### BRIEF DESCRIPTION OF THE DRAWINGS

FIG. 1 illustrates a preferred computing environment for providing apparel fit advisory service to individuals or users of the apparel fit advisory service in accordance with various embodiments of the present invention.

FIG. 2 schematically depicts an algorithm for determining an appropriate size or several sizes of an apparel for an individual and for providing apparel size recommendation in accordance with various embodiments of the present invention.

FIG. 3 illustrates an example of interrelation between the body measurement of an individual, measurement of an apparel item that the individual tried on, the fit preference and the fit assessment of said individual.

FIG. 4 is an exemplar table comprising indicators of fit of various apparels of one type and style to various individuals that tried the apparels on.

FIG. 5A illustrates a graph constructed based on the data contained in the table of FIG. 4, which illustrates interrelations among various individuals that tried on the apparels included in the table of FIG. 4.

FIG. 5B illustrates a graph constructed based on the data contained in the table of FIG. 4, which illustrates interrelations among various apparels that were tried on by the users included in the table of FIG. 4.

FIG. 6 illustrates a logical scheme of interactions of modules of a device operable to provide apparel size recommendations in accordance with various embodiments of the present invention.

FIG. 7 depicts a possible architecture of computing environment devices, in accordance with various embodiments of the present invention.

### DEFINITIONS

“Apparel elements” are defined as separate elements of apparel or any part of apparel's components which could be measured, e.g., “waist” or “inseam” of jeans or “sleeve length from center of back at base of neck to end of cuff of a shirt”. Hereinafter terms “element of apparel” and “dimension of apparel” are equivalents.

A “designation” of an article of apparel is defined as a set of the attributes of the article, other than its size. A designation comprises, but is not limited to, “type and style” and “model”, wherein “type and style” defines the type of fit (cut), and wherein “type and style” may also comprise “category of clothing”, gender name (man's or woman's or unisex cloth), age category (infants, children, teenagers, young adults, adults etc.) and so on, and “model” comprises model identity and brand name and/or manufacturer name. For example, a designation may be as follows: “Dress pants—men's—flat front—slim fit”, or “Levi's jeans—low rise—straight legs”, or “Levi's jeans—model 501”. Hereinafter, when referring to a model of an apparel, it is assumed that the type and style of the apparel is known or has been defined.

Hereinafter, when referring to apparels which are at least of the same type and style, the reader will understand that the apparels have the same type and style and may also have the same model as well. For notation, “at least of the same type and style” and “have designations matching, at least in part” are often used as equivalents. Thus, two or more designations of two or more apparels match each other if the apparels are of the same type and style but may also be of the same model.

“An indicator of fit” of an apparel of a certain model (of a certain designation) and size to an individual is defined either as a value or measure characterizing the fit of one of the apparel's elements or the fit of the apparel as a whole, or as a set of values or measures completely characterizing the fit of the apparel to the individual by characterizing the fit of the apparel's elements. Indicators of fit of an apparel of a certain model and size to an individual may factor in individual's body anatomy and individual's fit preferences for the apparel having designations matching, at least in part, the designation of the apparel of said certain model and size.

“An actual fit assessment” is defined as a value or measure given by an individual to an element of an apparel or to an apparel as a whole, or as a set of values or measures given to the apparel's elements when trying the apparel on, the assessment charactering the fit of the apparel's element or the apparel as a whole to the individual.

“A predicted fit assessment” is defined as a value or measure predicted by the present apparel fit advisory service for an individual for an element of an apparel or for an apparel as a whole, or as a set of values characterizing the fit of the apparel's element, or of the apparel as a whole, or of the several apparel's elements, respectively, that the individual would give to an element of an apparel, or to the apparel as a whole, or to several apparel's elements, respectively, if the individual had the opportunity to try the apparel on.

“Length fit assessments” or “Length assessments” comprise fit assessments given by the users or predicted by the present apparel fit advisory service for the users characterizing required enlarging or shortening of apparels elements denominated in measures of length to comply with individual fit preferences and body anatomy.

“Rating fit assessments” or “Rating assessments” comprise fit assessments given by the users or predicted by the present apparel fit advisory service for the users characterizing apparels fit by a dimensionless number that possess values from a certain scale of assessments where a lower absolute value means that the assessed apparel or its element has a better fit than the fit with the greater absolute value, and the number sign, if present, indicates whether the assessed apparel or its element should be larger or smaller to comply with individual's fit preferences and body anatomy.

“A fit assessment given by an individual to an apparel” is defined either as one fit assessment given by the individual to one element of the apparel or to the apparel as a whole, or as a set of fit assessments given by the individual to several elements of the apparel.

“A fit assessment predicted by the apparel fit advisory service for an apparel for an individual” is defined as one fit assessment or as a set of fit assessments predicted by the present apparel fit advisory service for the individual for one element of the apparel, for the apparel as a whole, or for several elements of the apparel, respectively.

“A selected user” is defined as a user for whom one or more fit assessments for the selected article of apparel are to be predicted.

An individual or a user for whom an appropriate size or several sizes of the apparel is to be determined may be referred to as a requester. Alternately a requester may be any other person, or it may be another entity such as an on-line retailer, or web-shop, or an on-line service including the present apparel fit advisory service, or any other business or third party initiating a request to the present apparel fit advisory service for apparel size recommendations. For notation, “a requester” may be referred to as “an initiator”, or “an individual”, or “a selected user or individual”, or “a user (of the apparel fit advisory service)”, or “a requesting user”.

“A selected article of apparel” is defined as an apparel having a selected designation for which one or more respective fit assessments related to one or more sizes of the apparel is to be predicted or an appropriate size of which is to be determined by the apparel fit advisory service. For notation, “a selected article of apparel” may be referred to as “a selected apparel” or “a selected designation”.

As used herein, the term “comparison” comprises, but is not limited to, direct as well as indirect comparison, wherein an indirect comparison between specified items employs comparison with and/or within additional, not specified, items. To illustrate, an indirect comparison between specified items A and C may be done through direct comparison of these items with an additional item B, wherein A is compared to C by first comparing A to B and then comparing B to C. Each of the items being compared may comprise a single object or a plurality (i.e., a set) of objects. When comparing an item that is a set of objects with another item, the comparison may be between the set as a whole and another item and/or between any subset of the set, including a single object from the set or all the objects constituting the set, and another item. To illustrate, when comparing a fit assessment given by an individual to an apparel with the respective fit assessment given by another individual to the same apparel, each of the two fit assessments may comprise several fit assessments related to various elements of the apparel.

As used herein, the term “and/or”, when used in a list of two or more items, means that any one of the listed items can be employed by itself, or any combination of two or more of the listed items can be employed. For example, if a composition is described as containing items A, B, and/or C, the composition can contain A alone; B alone; C alone; A and B in combination; A and C in combination; B and C in combination; or A, B, and C in combination. Items may be not only objects (things), interrelations between items (for example, conformities and similarities of objects), individuals and information or data but also states, operations (actions) for data processing and operations over objects, etc. To illustrate, if at some data operations A, B and/or C are being performed, it means that operation A may be performed alone; C alone; A and B in combination; A and C in combination; B and C in combination; or A, B, and C in combination.

As used herein, the articles “a”, “an”, or “the” before an item means that the item can be employed singular or plurally. To illustrate, when referring to the use of a fit assessment, it is assumed that at least one fit assessment is employed but also any number more than one of fit assessments may be employed. Or, when referring to the use (determining, providing, etc.) of the appropriate size of an apparel, it is assumed that at least one size of the apparel is employed (is being determined or provided at a time) but also any number more than one of fit assessments may be employed.

### DETAILED DESCRIPTION OF A PREFERRED EMBODIMENT OF THE INVENTION

In the following description, details of various embodiments in accordance with the invention are set forth and accompanying drawings are given. However, it will be apparent to those of ordinary skill in the art that alternative embodiments of the invention may be implemented using only some of the features of these embodiments, and using alternative combinations of the features of these embodiments, and it also will be apparent that these drawings are given for illustrative purposes only and are not meant to be limiting. These embodiments are described in sufficient detail to enable those skilled in the art to practice the invention. Other embodiments may be utilized and structural, logical and mathematical changes may be made without departing from the scope of the present invention.

In the following description, various operations are described herein in a particular order and as discrete tasks. However, it is to be understood that the order of description should not be construed to imply that the tasks involved in those operations must be performed in the order in which they are presented or that those tasks must be performed discretely. It should also be recognized that some operations described with respect to one embodiment may be advantageously incorporated into another embodiment. Further, in some instances, well known features are omitted or generalized in order not to obscure the description. In this description, the use of phrases such as “an embodiment”, “embodiments”, “alternative embodiment” and so forth do not necessarily refer to the same embodiment or all embodiments, although they may.

For various embodiments of the present invention, the term apparel refers to articles of different categories of clothing and footwear such as casual, dress, formal, sports, outdoor, working wear and so on, as well as various items related to them that are used along with wearing of clothes and footwear, such as different types of accessories, for example hats, gloves, belts, etc. For various embodiments of the present invention, the term apparel also refers to articles of equipment and supplies, which have at least one measurement, designed to put on humans or animals, such as climbing harnesses, sleeping bags, backpack suspension systems, pet harnesses, blankets and saddles, etc.

Embodiments of the present invention provide a computer implemented apparel fit advisory service (hereinafter referred to as “the apparel fit advisory service”) to provide an individual or a user of the apparel fit advisory service information about an appropriate size or several sizes of an apparel or several apparels for the individual based on predicting indicators of fit of the apparel or the apparels of various sizes to the individual and a subsequent comparison of said predicted fit indicators with the fit indicators compliant with the proper fit of apparels to individuals and/or a subsequent comparison of said predicted fit indicators with each other. The fit indicators compliant with the proper fit of apparels to individuals may be taken equal to zero. However, it will be apparent to those of ordinary skill in the art that alternatives to zero numerical values may be taken in the capacities of fit indicators compliant with the proper fit of apparels to individuals.

“An indicator of fit” of an apparel of a certain model and size (of a certain designation) to an individual is either a value or measure characterizing the fit of one of the apparel's elements or the fit of the apparel as a whole, or as a set of values or measures completely characterizing the fit of the apparel to the individual by characterizing the fit of the apparel's elements. Indicators of fit of an apparel of a certain model and size to an individual may factor in the individual's body anatomy and the individual's fit preferences for the apparel having designations matching, at least in part, the designation of the apparel of said certain model and size. The fit indicators vary from one size of the apparel to another one. Knowing only his or her own personal indicators of fit of an apparel of a certain model and size, an individual can explicitly define if the apparel fits or not without using any other information related to the apparel, such as measurements of the apparel.

For various embodiments of the present invention, in the capacity of the simplest indicators of fit of an apparel of a certain designation to an individual, which factor in an individual's body anatomy and fit preferences for the apparel having designations matching, at least in part, the designation of the apparel of said certain model and size, may be taken, but are not limited to, fit assessments given by the individual to one or more elements of the apparel or to the apparel as a whole when the individual tries the apparel on. The reader will recognize that fit assessments may comprise an individual user's subjective assessment (e.g., a preferred arm length of an individual's sport shirt) or may be otherwise dictated (e.g., an arm length of a military dress uniform shirt to be worn by the same individual).

Fit assessments may be provided to the apparel fit advisory service by users in symbolic, numerical, symbolic-numerical, graphic, audio and other formats that could be converted into the formats supported by computing devices. Preferred fit assessments should have the following features: 1) each particular fit of an apparel or an element of the apparel should correspond with only one fit assessment, or, if there are several fit assessments corresponding either with a particular fit of an apparel or an element of the apparel, it should be possible to distinguish between them so only the relevant fit assessments are applied when using fit assessments related to various apparels; 2) fit assessments data should have capabilities for ranking, i.e., fit assessments data could be compared using “more”, “less”, “equal”, “not equal” operations; 3) all fit assessments should be in the same dimension and scale or should be reducible to a common dimension and scale. Thus, each fit assessment (maybe after some transformations) may be represented as a number. For example, a fit assessment may be dimensionless and may be represented by a number with a plus or minus sign characterizing how well an element of an apparel of a certain model and size or the apparel as a whole fits an individual. In a preferred embodiment, a fit assessment possesses values from a certain scale of assessments where the lowest absolute value means that the assessed apparel or its element has a better fit than the fit with greatest absolute value. Moreover, the number sign indicates if the assessed apparel or its element should be larger or smaller to comply with individual fit preferences and body anatomy. Hereinafter such fit assessments are referred as rating fit assessments (rating assessments). To illustrate, if the fit assessment scale is represented by the following number sequence: −5, −4, . . . , −1, 0, +1, +2, . . . , +5, then the assessment 0 given by the user to an element of an apparel of a certain model and size means that the size of the element perfectly fits the user; the fit assessment −5 means that said element does not completely fit and it should be considerably larger (for example, the inseam of jeans of a certain model and size should be considerably longer, or the waist of the jeans should be considerably looser); the fit assessment +5 means that said element does not completely fit and it should be considerably smaller (for example, the inseam of jeans of a certain model and size should be considerably shorter, or the waist of the jeans should be considerably tighter). The fit assessments that are within the intervals −4 to −1 and +1 to +4 indicate that the element in question does not fit completely and should be greater or smaller depending on the number sign, and the degree of fit depends on the absolute value of the fit assessment. The set of fit assessments equaling zero determine fit indicators corresponding with a complete fit of apparels' elements, wherein the number of fit assessments in said set equals the number of elements of the apparel.

An alternative structure of the fit assessment scale may also be used. For example, the fit assessment scale may contain only nonnegative numbers or only positive numbers (nonnegative numbers and zero). In the first case the fit assessments compliant with the proper fit of apparels to individuals do not equal zero. If the fit assessment scale comprises positive as well as negative numbers, then it may be converted into a fit assessment scale comprising only nonnegative numbers using the ABS(fit assessment) operator. The fit assessment scale may be converted also into a fit assessment scale comprising only positive numbers using the 1+ABS(fit assessment) combinatorial operator. The fit assessments may be normalized so the fit assessment scale comprises numbers from 0 to +1. To illustrate, if the fit assessment scale is represented by the following number sequence: −5, −4, . . . , −1, 0, +1, +2, . . . , +5, then it may be normalized to a 0 to 1 range through the [ABS(fit assessment)]/5 operator.

Another type of fit assessments comprises fit assessments given by the users characterizing required enlarging or shortening of elements to comply with individual fit preferences and body anatomy, i.e., represented by a number with a sign and which have measures of length (for example, inches). Hereinafter such fit assessments are referred as length fit assessments (length assessments).

If a measurement of an article is a circumference measurement, such as waist, neck or head measurement, etc., then an individual may select one of the two types of fit assessment when entering apparel fit assessment values. One type of assessment is an alteration of the diameter of an element for appropriate fit. Another type of assessment is an alteration of the circumference of an element for appropriate fit. The apparel fit advisory service may automatically convert diameter fit assessments into perimeter fit assessments and vice versa so the fit assessment data stored in the apparel fit advisory service are in the same format.

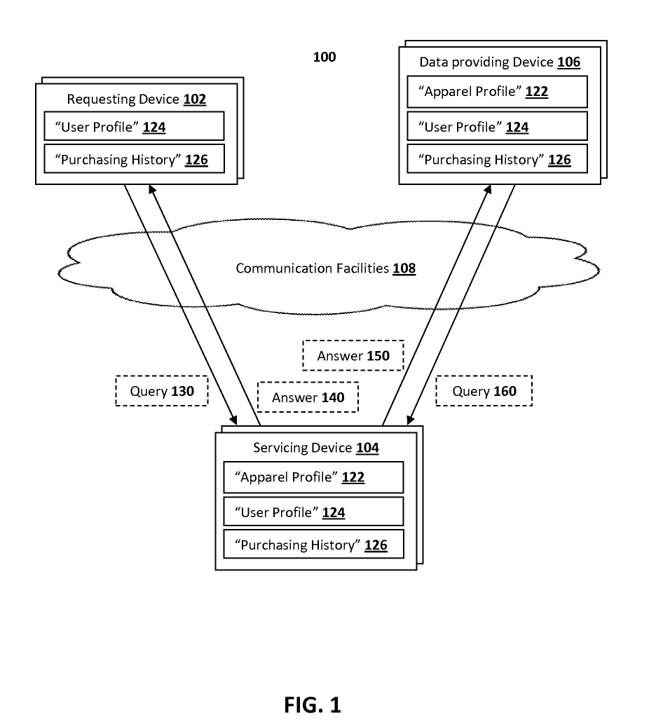

FIG. 1 illustrates a preferred computing environment 100 for providing apparel fit advisory service to individuals or users of the apparel fit advisory service in accordance with various embodiments of the present invention. As illustrated, a computing environment 100 includes requesting devices 102, servicing devices 104, and data providing devices 106 connected via communication facilities 108. A requesting device 102 is a device adapted to perform the following main operations: generating and sending requests 130 to servicing devices 104 for providing apparel size recommendations (apparel recommendations) for selected apparels to a selected individual and receiving apparel recommendations 140 generated by servicing devices 104 in response to requests 130. A servicing device 104 is a device adapted to perform the following main operations: receiving from requesting devices 102 requests 130 for providing apparel recommendations 140; analyzing data stored on the requesting device 102 and/or on the servicing device 104 and/or contained in the received request 130; generating and sending to data providing devices 106 requests 150 for providing information related to individuals' purchases and to individuals who bought said purchases and/or for providing information about results of a comparison between data contained in the received request 130 and/or received from the requesting device 102 and/or stored on the servicing device 104 related to individuals' purchases and to individuals who bought said purchases and the respective data stored on the data providing devices 106 if it was revealed during the operation of analyzing data that such information is needed for providing apparel size recommendations 140; receiving from the requested data providing devices 106 replies 160 containing said requested information in response of requests 150; servicing requests 130 and providing apparel size recommendations 140 in response of requests 130. A data providing device is a device adapted to perform the following main operation: receiving from servicing devices 102 requests 150 and providing replies 160 containing the requested information related to individuals' purchases and to individuals who bought said purchases and/or performing a comparison between data contained in the received requests 150 and the respective data stored on the data providing device 106. Each of the devices in the computing environment 100 may at the same time be a requesting and/or a servicing and/or a data providing device. At least a part of the present apparel fit advisory service may be operated by any of the devices 102-106. Communication facilities 108 may be a public or private network if interacting devices 102-106 are separate devices, or they may be software and/or hardware means if several devices 102-106 are incorporated in one device.

For various embodiments of the present invention, the types of the devices 102-106 and their owners may be different. The owner of any of the devices 102-106 may be an individual, or an on-line retailer, or web-shop, or an on-line service provider including the present apparel fit advisory service provider, or any other business or third party. Accordingly, any of the devices 102-106 may be a personal computing device, such as a cell phone, or communicator, or a similar handheld device, or a PC or a tablet PC, or it may be a server. Thus, an initiator or a requester of a request 130 may be an individual or a business or a third party that submitted the request through a device 102 or 104, or it may be any of the devices 102-106 that generated the request for a user automatically. For notation, an “initiator” or a “requester” of a request may be referred to as “an individual” or “a user (of the apparel fit advisory service)” or “a selected user or individual”.

For various embodiments of the present invention, data stored on each of the devices 102-106 may include, but is not limited to, data 122 related to various apparels, data 124 related to various individuals or users of the apparel fit advisory service, and data 126 related to various apparels and associated with users having purchased the apparels. The devices 102-106 may also be adapted to perform an additional operation of storing data 122-126 received from a user or from any other device 102-106, for example, data contained in the requests 130, 150 or in the answers 140, 160. Data 122, 126, and 124 that are received may be stored by the receiving device in established users' profiles, users purchasing histories, and apparels' profiles, respectively, or the receiving device may update existing, already established, profiles and/or purchasing histories with the received data. For notation, data 122 related to an apparel may be referred to as an apparel profile, for which the same numeration 122 may be used. Also, data 124 related to a user of the apparel fit advisory service may be referred to as a user profile. Moreover, the same numeration 124 may be used for identification of a user profile. In addition, data 126 related to various apparels associated with a user who purchased the apparels may be referred to as a user purchasing history, for which the same numeration 126 may be used. Apparel data 122 related to apparels may be in a form of records, i.e. Record {Apparel's Designation, Apparel's Data}. Also, user profiles 124 and purchasing histories 126 may be in a form of records, i.e. Record {User's Identity, Individual's Data} and {User's Identity, Apparels' Designations, Apparels' Data}, respectively. Thus, all records stored on the devices 102-106 form a plurality or a set of records of the apparel fit advisory service. This set of records may comprise, but is not limited to, three subsets of records: 1) users profiles 124; 2) users purchasing histories 126; and 3) apparel profiles 122. Several records stored on one or more devices 102-106 may be captured in a centralized or a distributed database. The databases may be managed by a database management system (DBMS), or by a distributed database management system (DDBMS), or by a heterogeneous database management system (H DBMS). Hereinafter a database comprising several records may be designated with the same number as the records included in the database. Data 122-126 stored on the devices 102-106 may be updated and recalculated to reflect changes in apparels' and individuals' characteristics, fit preferences of individuals, etc.

For various embodiments of the present invention, an apparel profile 122 related to an apparel may include care instructions and information about changes of or the rules of changes of characteristics of the articles of the apparel from one size to another. A profile 124 of a user of the apparel fit advisory service may comprise various essential personal information such as gender, age, weight, individual's physical body measurements and other parameters characterizing anthropometric peculiarities of the individual, and so on. Purchasing history 126 of the individual may comprise information about the individual's purchases such as designations and sizes of purchased apparel and fit assessments given by the individual to the individual's purchases and/or fit indicators of individual's purchases as well as dates of purchases and dates of assessing the apparels. Purchasing history 126 of the individual may additionally include information about usage of the apparel: usage time (period of wearing), usage intensity, number and intensities of washings and other treatments, wear, and any other data needed for fit assessments adjustment (correction) as described in the embodiments below.

For various embodiments of the present invention, a request 130 may contain information related to an individual for whom an appropriate size of an apparel is determined as well as information related to the apparel the appropriate size of which is to be determined. Said information related to the individual may comprise the following data: individual identity, gender, age, weight, individual's physical body measurements and other parameters characterizing anthropometric peculiarities of the individual, individual preferences in fit of apparels of various types and styles and so on. A unique individual identity label or the like may be assigned by the apparel fit advisory service to an individual when he or she registers an account at the apparel fit advisory service. An individual identity may comprise a user's name and/or login for unique identification of the user and associating information stored in the user's profile 124 and the user's purchasing history 126 with the individual. Said information related to the apparel may comprise the following data: the designation of the apparel the appropriate size of which is determined, designations, sizes of and fit assessments given by the individual to apparels that the individual had tried on and which have designations matching, at least in part, the designation of the apparel the appropriate size of which is determined or fit indicators of an apparel that the individual had tried on and which have designations matching, at least in part, the designation of the apparel the appropriate size of which is determined as well as dates of purchases and dates of assessing the apparels. Said information related to the apparel may additionally include the following data about usage of the apparel: usage time (period of wearing), usage intensity, number and intensities of washings and other treatments, wear, and any other data needed for fit assessments adjustment (correction) as described in the embodiments below.

A request 130 may be in a form of a query, e.g., Query {User's Identity, Individual's Data, Apparel's Data}. An apparel size recommendation 140 may be in the form of an answer, e.g., Answer {Size1, Size2, . . . } or {Apparel1, Size1, Apparel1, Size2, . . . }, wherein Apparel1, Apparel2, . . . are the designations of the respective apparels.

In various embodiments of the present invention, a request 130 having the form of a query, may comprise, in part related to “Apparel's Data”, in addition to information on brand names, models, sizes and fit assessments given by the individual to the apparel that the individual tried on and that have designations matching, at least in part, the designation of the apparel for which an appropriate size is to be determined, information only on the type, or information only on the type and style, or information only on the type and the brand name (manufacturer), or information only on the type, style and brand name (manufacturer) of an apparel an appropriate size of which is determined. In such cases the apparel fit advisory service may return a null result when providing apparel size recommendation for an apparel for an individual and inform the requester of its inability to recommend an appropriate size of the apparel, or the apparel fit advisory service may convert the request 130 into a chain of consecutive requests, each of which is supplemented with the information on certain model of the apparel an appropriate size of which is determined, thus the models in each consecutive request are different. In the last case mentioned above the apparel fit advisory service functions not as a simple convertor of the sizes of the articles of apparel of the selected model across different manufacturers or as a “the right size advisor” but as a service that determines for an individual one or several apparel brands or apparel manufacturers producing apparel having the best fit to the individual, which are of the same type and style as the selected article of apparel.

To illustrate, if the request 130 contains information only on the type “Jeans” of an apparel, an appropriate size of which is to be determined, then the apparel fit advisory service converts the request 130 into a chain of consecutive requests: 130.1, 130.2, . . . , 130.n, . . . , 130.m, . . . , 130.p, 130.q, . . . , 130.t, . . . , 130.y, . . . , 130z, which are consecutively serviced and in response to each of said requests the apparel fit advisory service provides an apparel size recommendation. The requests 130.1, . . . , 130.n are supplemented with additional information in a way that the apparel fit advisory service, when servicing these requests, provides apparel size recommendations on appropriate sizes of jeans of a brand name “A” and style “regular” and models “A₁”, “A₂”, . . . “Aₙ” respectively, wherein n—number of models of jeans of style “regular” being produced and/or were produced by the manufacturer “A”. The requests 130.m, . . . , 130.p are supplemented with information in a way that the apparel fit advisory service, when servicing these requests, provides apparel size recommendations on appropriate sizes of jeans of a brand name “A” and style “slim fit” and models “B₁”, “B₂”, . . . “Bₚ₋ₘ” respectively, wherein p-m—number of models of jeans of style “slim fit” being produced and/or were produced by the manufacturer “A”. The requests 130.q, 130.t are supplemented with information on models of jeans of other styles which are available or were available in the nomenclature of styles of the manufacturer “A”. Thereby, the requests 130.1, . . . , 130.t contain requests on providing an appropriate size of each model of jeans of various styles being produced and/or were produced by the manufacturer “A”. The requests 130.y, . . . , 130.z are similarly supplemented with the information on various models of jeans of various manufacturers (“B”, “C”, . . . ). Instead of providing an apparel size recommendation in response to each of the requests, which all constitute the chain of the requests, the apparel fit advisory service may consecutively service these requests and provide one recommendation on the size of that article of jeans which has the best fit among all jeans having various designations and being produced by various manufacturers. In lieu of, or in addition to such recommendation the apparel fit advisory service may provide a generalized recommendation about the brand name of that manufacturer which produces various jeans having the best fit to the individual. The recommendation about such a manufacturer (or brand) to an individual may be implemented by the apparel fit advisory service based on, for example, the results of comparison of the degrees of fit of elements for various jeans or the degrees of fit of various jeans as a whole (without factoring in the fit of various elements) and on the quantity of jeans having an appropriate fit to the individual being produced by each of the manufacturers. Moreover, for various embodiments of the present invention, a request 130 having the form of a query in the part related to “Apparel's Data” besides the information on brand names, models, sizes and fit assessments given by the individual to the apparel that the individual tried on may not contain any additional data. In such cases the apparel fit advisory service converts the request 130 into a chain of consecutive requests, wherein this chain has the structure similar to one described above, and wherein the requests of this chain are consecutively supplemented with various types, styles, models, and sizes of apparel. The ability of providing recommendations, not only for the selected article of apparel, but for apparel of a certain type, or even for an apparel for which type, style and model were not selected by the requester, may be useful and required when the requester chooses a single brand to stay within this preferred brand buying apparel of various types and styles. It also could be useful when the apparel fit advisory service is integrated or coupled with, at least in part, an on-line shopping system. In such cases, when a buyer visits such an on-line shopping system to buy, for example, jeans with an appropriate size, the buyer may retain the apparel fit advisory services if the buyer does not have preferences in a specific brand of jeans or the buyer equally prefers several brands of jeans. Instead of receiving recommendations from the apparel fit advisory service about an appropriate size for each certain model of jeans available within the on-line shopping system and then selecting jeans of a certain model and of a certain size having the best fit, a request may be composed for the buyer which, after being processed, initiates apparel fit advisory service to provide recommendations on that model of jeans of that manufacturer which have the best fit among the jeans of various brands, styles, models, and sizes that are available within the on-line shopping system. The apparel fit advisory service may also recommend that model of jeans, among the jeans having the same appropriate fit, for which other complimentary items of apparel of the same brand as the jeans are available within the on-line shopping system. To illustrate, if the apparel fit advisory service has determined that there are two articles of jeans of the manufacturers “A” and “B” having the same appropriate fit available within the on-line shopping system, then it may recommend the jeans of the brand “A” since there are also t-shirts of the brand “A” having an appropriate fit available within the on-line shopping system while t-shirts of the brand “B” having an appropriate fit are unavailable in the on-line shopping system.

For various embodiments of the present invention, the apparel fit advisory service may contain or may be integrated or coupled with, at least in part, a price comparison system or an on-line shopping system. Thus a Query 130 and/or an Answer 140 may also include additional information. For example, a Query 130 and/or an Answer 140 may also include information on on-line or brick-and-mortar stores containing the name of the store, location of or web-link to the store, contact information of the store, a web-link to a web-page containing the goods description and so forth. Said capability of interaction between the apparel fit advisory service and other systems gives the users and buyers of the systems the opportunity to provide the apparel fit advisory service with their fit assessments when they receive purchased apparel or when they make a decision to return or exchange their purchases. Buying may be organized in a way that at the next purchase the buyer will be asked to fill in a Customer Satisfaction Form containing fields where the buyer should indicate fit assessments given to the already purchased apparel or should indicate if there is any difference between the fit assessments predicted by the apparel fit advisory service for the previous purchases and the respective actual fit assessments given by the buyer after receiving them. Return or exchange may be organized in a way that purchased apparel will be returned or exchanged after filling in a Return/Exchange Form containing fields where the buyer should indicate fit assessments given to the purchased apparel. In processing a buyer's fit assessment information, an on-line shopping system may determine an appropriate size of an apparel with the use of the apparel fit advisory service at the exchange or may use said information for determining an appropriate size of an apparel that has a designation matching, at least in part, the designation of the returned apparel at follow-up purchases of the buyer.

For various embodiments of the present invention, a request 150 may be in a form of a query, e.g. Query {User's Identity, Profile Data Type, Purchasing History Data Type}, or Query {User's Identity, User's Profile Data, User's Purchasing History Data} depending on what kind of the request is submitted. The parts of a request 150 related to “Profile Data Type” and to “Purchasing History Data Type” contain the types of the data, the data being received in a reply 160 in response to the query 150. The parts “Profile Data Type” and “Purchasing History Data Type” comprise the identifiers of the types of data contained in the users' profiles and users' purchasing histories, respectively. The parts of a request 150 related to “User's Profile Data”, “User's Purchasing History Data” contain those data objects from user's profiles and user's purchasing history, respectively, that should be compared by a data providing device 106, which has received the request 150, with the respective data stored on the providing device 106. A reply 160 may be in a form of an answer, e.g. Answer {User's Identity, User's Profile Data, User's Purchasing History Data} or Answer {User's Identity, Profiles Data Comparing Results, Purchasing Histories Data Comparing Results}. The parts “User's Profile Data” and “User's Purchasing History Data” comprise data requested in the request 150 stored on the data providing device 106. The parts “Profiles Data Comparing Results” and “Purchasing Histories Data Comparing Results” contain the results of the comparison of the data containing in the received request 150 with the respective data stored on the data providing device 160. To illustrate, the part “Purchasing Histories Data Comparing Results” may comprise the results of comparison between a set of fit assessments contained in the request 150 related to a user and the respective set of fit assessments stored on the data providing device 160 related to another user.

For various embodiments of the present invention, the part “User's Identity” may be eliminated from the Queries 130, 150 and from the Answers 140, 160 for anonymity purposes and/or for enhancing the security level.

In an embodiment of the present invention, the apparel fit advisory service may be a centralized system. In this system, some of triplets of the devices 102-106 are integrated into one or several central devices of the apparel fit advisory service, which may be one or several servers of the apparel fit advisory service. The databases stored on the apparel fit advisory service servers may include, but are not limited to, databases containing data on users' profiles 124 and purchasing histories 126, and also containing data on apparels' profiles 122. The data stored in the databases 122-126 may be supplemented with new data irrespectively from the incoming requests 130. In this case the data supplement may be realized by obtaining from other devices of the system the respective data stored on them. For example, an individual may send to the apparel fit advisory service servers data on newly purchased apparels, or a web-shop may send one or more users' profiles and purchasing histories. Individuals may submit their requests 130 through personal devices 102, and other users, such as web-shops, may submit their requests 130 through devices that may be a combination of the devices 102-106 to the apparel fit advisory service servers. The servers of the apparel size may analyze data related to individuals and apparels contained in a request 130 and in the databases 122-126 stored on the servers to reveal the completeness and latitude of data used for determining an appropriate size of an apparel. If during the analysis it is revealed that the analyzed data is not sufficient for completion of the request 130, the apparel fit advisory service servers may generate requests 150 for providing missing data and distribute the generated requests 150 to at least a part of all devices of the apparel fit advisory service adapted to receive the requests 150 and to provide, in response of requests 150, replies 160 containing the requested data. Using the data contained in a request 130 and in the databases 122-126 and the data received in the replies 160, the apparel fit advisory service servers complete the received request 130 and provide to the requestor apparel size recommendations 140 in response of the request 130.

In an alternate embodiment of the present invention, the apparel fit advisory service may be decentralized. In this system users' devices are combinations of the devices 102 and 104, so any of the devices of the system may send a request 130 to any other device of the system. A user device converts the request 130 into a number of requests 150 and distributes the generated requests 150 to at least a part of other users' devices. The requests 150 may be either on providing by another user's devices, by means of replies 160, users' profiles and users' purchasing histories data stored on the other users' devices, or on comparing the user's profile and the user's purchasing history data of the requester contained in the requests 150 with the respective data of the other users stored on the other user's devices and providing the results of the comparison in the replies 160. The last mentioned above case ensures enhanced security since no other device of the apparel fit advisory service, except the requesting device, reveals data stored on the device. Using the data contained in a request 130 and the data received in the replies 160, the requesting device completes the received request 130 and provides the apparel size recommendations 140 in response of the request 130. Any person skilled in the art may easily apply the exemplar centralized or decentralized systems or any combination of them, or may develop new systems using mentioned devices and facilities of the computing environment 100 for more precise conformity between the apparel fit advisory service realization and a contemporary state of the art.

For various embodiments of the present invention, an apparel fit advisory service may have presets of accuracy (minimum unit of measure) and required formats for the data received from individuals, apparel manufacturers, retailers, web-shops, or any other business or third party in cases where the data received have dimension of length. For example, the apparel fit advisory service may have such presets that the values of length provided by users of the service should be multiples of

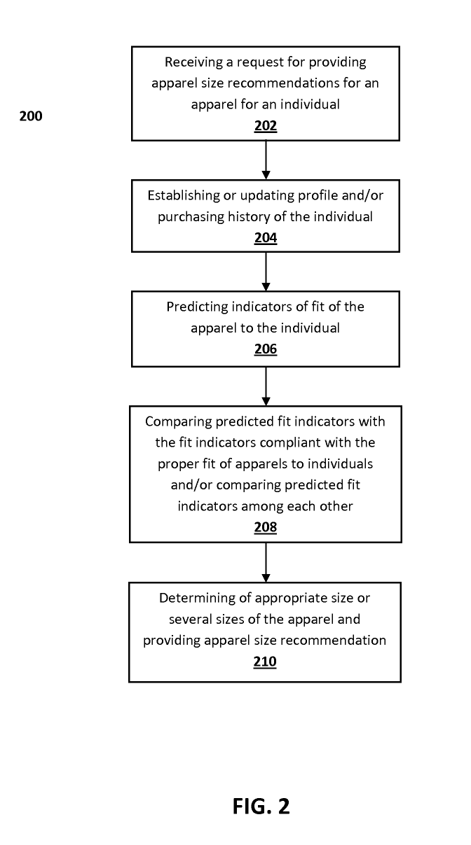

FIG. 2 illustrates a preferred algorithm 200 for determining an appropriate size or several sizes of an apparel for an individual and providing apparel size recommendation in accordance with various embodiments of the present invention. As illustrated, the algorithm 200 comprises a sequence of the following operations: receiving 202 a request for providing apparel size recommendations for an apparel for an individual; establishing or updating 204 profile 124 and/or purchasing history 126 of the individual; predicting 206 indicators of fit of the apparel to the individual for whom an appropriate size of the apparel is determined; comparing 208 said predicted fit indicators with the fit indicators compliant with the proper fit of apparels to individuals and/or with others of the set of predicted fit indicators; determining appropriate size or several sizes of the apparel and providing apparel size recommendation 210 based on at least a part of the results of comparing 208.

In an embodiment of the present invention, as previously discussed, the apparel fit advisory service may establish or update a profile 124 and/or purchasing history 126 of an individual using data available in a request 130 of the user and analyzing this data. In cases where data in a received request 130 does not contain an individual identity, the apparel fit advisory service establishes, in the course of performing operation 204, a user's profile 124 and purchasing history 126 and stores data related to the individual, to apparel the appropriate size of which is to be determined and to apparels that have designations matching, at least in part, the designation of the apparel the appropriate size of which is to be determined and that were derived from the request 130. In cases where the data in a received request 130 contains an individual identity, the apparel fit advisory service may update, in the course of performing operation 204, the user's profile 124 and purchasing history 126 with data related to the individual and to the apparel the appropriate size of which is to be determined, where these data were obtained from the request 130. Hereinafter, when referring to data contained in the profile 124 and the purchasing history 126 of a user, it is assumed that the data in the profile 124 and in the purchasing history 126 are supplemented by information from the requests 130 submitted by the user. In an alternate embodiment of the present invention, the apparel fit advisory service may use data that are provided with the individual's request 130 without establishing the individual's profile 124 and/or purchasing history 126.

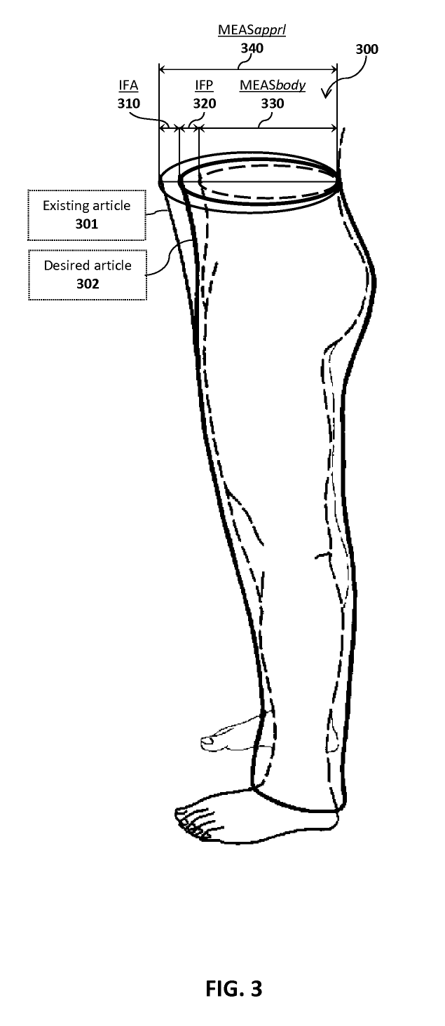

FIG. 3 illustrates, and equation 1 determines an interrelation 300 between fit assessments given by a selected individual to a selected apparel 301 of a certain model and size, the corresponding fit preferences 320 of the individual and the measurements 340 of the apparel's elements that are assessed:

IFAapprlᵢ=MEASapprlᵢ−(MEASbodyᵢ+IFPᵢ), [Equation 1]

wherein IFAapprlᵢ 310—the fit assessment given by an individual to the i-th element of the apparel; MEASapprlᵢ 340—the i-th measurement of the apparel corresponding with the i-th element of the apparel; MEASbodyᵢ 330—the i-th body measurement of the individual corresponding with the i-th element of the apparel; and IFPᵢ 320—the value of preference of the individual in fit of the i-th element of apparels that have designations matching, at least in part, the designation of the apparel.

Equation 1 and FIG. 3 demonstrate that a fit assessment 310 given by the owner to an element of an apparel 301 of a certain model and size is explicitly determined by corresponding body measurement 330 of the owner and the owner's preferences in fit of said apparel's element 320, provided that the measurement 340 of said element is known. In cases when an appropriate size of an apparel 302 is determined for a selected individual, the values of predicted fit assessments of the apparel for the user determine fits of elements of the apparel to the selected individual.

Equation 1 also demonstrates that the indicators (in particular, fit assessments) of fit of an apparel to a user may be determined by the apparel fit advisory service. For example, said determination may be based on measurements of the apparel provided by the user and based on at least a part of the data stored in the profile 124 and/or purchasing history 126 of the individual. Thus, for various embodiments of the present invention, more compound and complex fit indicators than fit assessments given by users may be used for determining appropriate sizes of apparels for users.

Equation 1 also demonstrates that equality of fit assessments of two different users corresponding with the same element of an apparel of the same model and size means that the element equally fits both users. Thus, if the user “A” has two apparels of the same type and style of models “a” and “b”, and the user “B” has the apparel “a” of the same size as the user “A”, it is most likely that the interrelation between indicators of fit of the apparel “a” to the user “A” and to the user “B” that are denominated in measures of length will be the same for the apparel “b” since fit preferences of any individual are constant for various apparels of the same type and style. Said interrelation between fit indicators may be expressed as a function. For example, a mathematical difference between fit assessments given by two users to the same apparel of a certain model and size may stay unchanged for any apparel having a designation matching, at least in part, the designation of said apparel. Thus, for various embodiments of the present invention, predicting 206 indicators (in particular, fit assessments) of fit of an apparel to a user may be based on information on indicators of fit of various apparels to said user, provided that said various apparels have designations matching, at least in part, the designation of said apparel and also provided that the user had tried said various apparels on, and based on indicators of fit of said various apparels to other users.

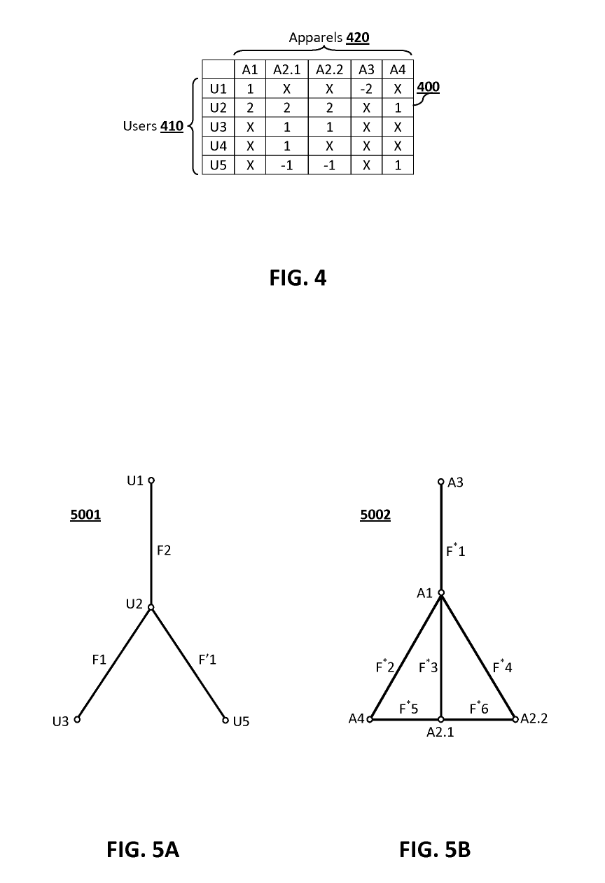

FIG. 4 illustrates an example of a table 400 comprising indicators of fit of apparels 420 Al, A2.1, A2.2, A3, A4 to users 410 U1-U5 available within the apparel fit advisory service, wherein said apparels are of the same type and style and wherein said fit indicators relate to one element of said apparels (for example, relate to waist dimension of jeans). Apparels A2.1 and A2.2 relate to apparel of a certain model A2 (not shown) but have different sizes (for example, A2 is the jeans “Levis—model 501”, A2.1 is the jeans A2 with the waist size of 30, A2.2 is the jeans A2 with the waist size of 31). Each column of the table 400 comprises fit indicators related to said element of apparel of one certain model and size. Each cell of the table 400 is located at intersection of a row corresponding with a certain user and a column corresponding with said element of an apparel. A cell containing the symbol “X” indicates that the user did not try the apparel on and/or that there is no data available within the apparel fit advisory service on an indicator of fit of the apparel to the user, which corresponds with said element of the apparel.

In one embodiment of the present invention, predicting 206 of indicators of fit of the selected apparel of the selected size for a selected user may be based on the use of fit indicator data taken only from other users who had tried on apparels having the same designation as the selected apparel. In such cases a functional interrelation between predicted indicators of fit of the selected apparel of the selected size for the selected user and corresponding indicators of fit of the selected apparel of the selected size to other users may be determined by any of the following equations 2, 3, or 4:

$${PFI}_{{A}_{i}} = \frac{{\sum }_{j = 1}^{n} ( {Sim}_{i} ( {U}_{P} , {U}_{j} ) \times {AFI}_{{U}_{j} i} )}{{\sum }_{j = 1}^{n} {Sim}_{i} ( {U}_{P} , {U}_{j} )} , \qquad [ Equation 2 ]$$

wherein PFI_{A}_{ᵢ}—predicted indicator of fit of the i-th element Aᵢ of the selected apparel A of the selected size to the selected user Uₚ; Simᵢ(Uₚ,Uⱼ)—correlation coefficient between actual indicators of fit of the i-th element of various apparels to the selected user Uₚ and actual indicators of fit of the i-th element of the same apparels to another user Uⱼ, wherein said various apparels have designations matching, at least in part, the designation of the selected apparel A. To illustrate, Simᵢ(Uₚ,Uⱼ) may be a correlation coefficient between respective actual fit indicators included in the rows of the table 400, wherein each of the compared rows comprises at least one fit indicator related to a designation matching, at least in part, the designation of the selected apparel A; AFI_{U}_{ⱼ}ᵢ—actual indicator of fit of the i-th element Aᵢ of the selected apparel A of the selected size to the user Uⱼ; i—sequential number (or identifier) of an element of the selected apparel A. In this equation i may take any value within the interval [1, n], wherein n—number of elements of the selected apparel A; j—sequential number of a user with whom associated actual fit indicators of the selected apparel A are available within the apparel fit advisory service; j consecutively takes values from the interval [1, m], wherein m—number of users with whom associated actual indicators of fit of the selected apparel A are used for predicting PFI_{A}_{ᵢ}. The apparel fit advisory service may take for m the number of all users with whom associated actual indicators of fit of the selected apparel A are available within the apparel fit advisory service or only a part of said users that are included in the selected list of users (as described in another embodiment below).

$$\begin{matrix}{PFI}_{{A}_{i}} = \frac{{\sum }_{j = 1}^{n} ( {Sim}_{i} ( {U}_{p} , {U}_{j} ) \times ( {AFI}_{{U}_{j} i} + {\overline{AFI}}_{{U}_{P} i} + {\overline{AFI}}_{{U}_{j} i} ) )}{{\sum }_{j = 1}^{n} {Sim}_{i} ( {U}_{P} , {U}_{j} )} , & [ Equation 3 ] \\ {PFI}_{{A}_{i}} = \frac{{\sum }_{j = 1}^{n} ( {sim}_{i} ( {U}_{p} , {U}_{j} ) \times {AFI}_{{U}_{j} i} )}{{\sum }_{j = 1}^{n} {Sim}_{i} ( {U}_{P} , {U}_{j} )} + {\overline{AFI}}_{{U}_{P} i} + {\overline{AFI}}_{{U}_{j} i} , & [ Equation 4 ]\end{matrix}$$

wherein A̅F̅I̅_{U}_{ₚ}ᵢ and AFI_{U}_{ⱼ}ᵢ—mean values of actual indicators of fit of the i-th element of various apparels to users Uₚ and Uⱼ, accordingly, wherein said various apparels have designations matching, at least in part, the designation of the selected apparel A.

Correlation coefficient Simᵢ(Uₚ,Uⱼ) in equations 2-4 may be determined, for example, as Spearman correlation coefficient and may be represented by the following equation 5:

$${Sim}_{i} ( {U}_{P} , {U}_{j} ) = \frac{{\sum }_{k = 1}^{l} ( {R}_{{U}_{P} ik} - {\overline{R}}_{{U}_{P}} ) ( {R}_{{U}_{j} ik} - {\overline{R}}_{{U}_{j}} )}{\sqrt{{\sum }_{k = 1}^{l} {( {R}_{{U}_{P} ik} - {\overline{R}}_{{U}_{P}} )}^{2} {\sum }_{k = 1}^{l} {( {R}_{{U}_{j} ik} - {\overline{R}}_{{U}_{Pj}} )}^{2}}} , \qquad [ Equation 5 ]$$

wherein the raw scores comprising said above actual fit indicators associated with the users Uₚ and Uⱼ are converted to the ranks R_{U}_{ₚ}ᵢₖ and R_{U}_{ⱼ}ᵢₖ. Hence, R_{U}_{ₚ}ᵢₖ is the rank of the actual indicator of fit of the i-th element of the k-th apparel to the selected user Uₚ, and R_{U}_{ⱼ}ᵢₖ is the rank of the actual indicator of fit of the i-th element of the k-th apparel to the user Uⱼ, wherein said k-th apparel has a designation matching, at least in part, the designation of the selected apparel A. One has to assign the same rank to each of the equal values of actual fit indicators. It is an average of their positions in the ascending (or descending) order of the values that are indicated as R-bar. To illustrate, if actual fit indicators associated with the selected user Uₚ are the following: 1, 3, 3, 2, then the corresponding position of each of these fit indicators in the descending order are the following: 4, 2, 1, 3. The ranks of the two fit indicators that equal 3, which have positions 2 and 1 in the descending order, should be the same, so the average of their positions is 1,5=(2+1)/2. Thus, the ranks of the given above actual fit indicators are respectively the following: 4, 1.5, 1.5, 3.

The term “overlap” of fit indicators associated with two users means that there is at least one indicator of fit of the respective at least one element of at least one apparel to one user and there is at least one indicator of fit of the same at least one element of the same at least one apparel to another user. Alternatively, overlap means that there is at least one indicator of fit of at least one apparel associated with a first user and there is at least one indicator of fit of the same at least one apparel associated with a second user if the fit indicators are related to the respective articles of apparel as a whole (but not to individual elements of the respective articles of apparel). In other words, the term “overlap” (of fit indicators associated with two users) means that at least one set of fit indicators associated with a first user and at least one set of fit indicators associated with a second user overlap, i.e. at least one set of fit indicators associated with the first user and at least one set of fit indicators associated with the second user comprise at least one fit indicator from the at least one set associated with the first user and at least one fit indicator from the at least one set associated with the second user that relate to the same article of apparel. Overlapping does not necessarily mean that one or more overlapped fit indicators associated with the one user are equal to one or more corresponding overlapped fit indicators associated with another user. For notation, an “overlap of fit indicators associated with the users” may be referred to as “overlap between the users”, wherein two or more users overlap with each other if the respective sets of fit indicators associated with these users have mutual overlaps.

The correlation coefficient Simᵢ(Uₚ,Uⱼ) in equations 2-4 may also be determined, for example, as a Jaccard index and may be represented by the following equation 6:

$${Sim}_{i} ( {U}_{P} , {U}_{j} ) = \frac{Count ( {U}_{p} ⋂ {U}_{j} )}{Count ( {U}_{P} ⋃ {U}_{j} )} \times \frac{Count ( {U}_{P} ⋂ {U}_{j} )}{Count ( {U}_{P} )} , \qquad [ Equation 6 ]$$

wherein Count(Uₚ ∩ Uⱼ)—function returning the number of actual fit indicators comprising the set that is an intersection of two following sets: a set of indicators of fit of the i-th element of apparels to the selected user Uₚ and a set of indicators of fit of the i-th element of apparels to the user Uⱼ, wherein said apparels have designations matching, at least in part, the designation of the selected apparel A (i.e., Count(Uₚ ∩ Uⱼ)—function returning the number of overlapped fit indicators of the users Uₚ and Uⱼ); Count(Uₚ∪ Uⱼ)—function returning the number of actual fit indicators comprising the set that is a union of the two said sets accordingly associated with the users Uₚ and Uⱼ; Count(Uₚ)—function returning the number of actual fit indicators included in the set of indicators of fit of the i-th element of apparels to the selected user Uₚ.

In the capacity of correlation coefficients Simᵢ(Uₚ,Uⱼ) may also be used, but are not limited to, Kendall or Pearson correlation coefficients.

In Equations 2-5 and hereinafter actual indicators of fit of an apparel to a user means indicators of fit of that apparel which said user tried on, while predicted indicators of fit of an apparel to a user means indicators of fit of that apparel which said user hasn't tried on and for which an appropriate size for said user is determined. A plurality of fit indicators given by a user to various articles of apparel having the same type and style may form the set of fit indicators associated with the user. The fit indicators comprising a set may relate either to apparels' elements or to articles of apparels as a whole.

The method of predicting fit indicators described in the embodiment above uses information on fit indicators corresponding only with those users associated with fit indicators having an overlap with fit indicators associated with the user for whom an appropriate size of an apparel is determined. In this method the correlation coefficient Sim(Uₚ,Uⱼ) cannot be determined without an overlapping of actual fit indicators associated with the users Uₚ and Uⱼ

An alternative embodiment of the present invention enables predicting fit indicators for cases when actual fit indicators associated with users Uₚ and Uⱼ do not overlap. In this embodiment, determining interrelations and/or conformity and/or similarity between fit indicators associated with said user Uⱼ and corresponding fit indicators associated with the user Uₚ is based on the use of information on other users' fit indicators having mutual overlaps, wherein fit indicators associated with at least one of said other users should overlap with fit indicators associated with the user Uⱼ as well as to the user Uₚ, or fit indicators associated at least with one of said other users should overlap with fit indicators associated with the user Uⱼ and fit indicators associated with at least one more user of said other users should overlap with fit indicators associated with the user Uₚ. As an example, as it is illustrated in the FIG. 4, fit indicators associated with the users U3 and U5 specified in the table 400 do not overlap with fit indicators associated with the user U1 (i.e., the selected user) for whom an appropriate size of the apparel A2 (i.e., selected apparel) of the selected size is being determined (in the table 400 each of identifiers A1-A6 comprises a certain designation as well as a certain size). At the same time, fit indicators associated with the user U2 (i.e., the other user) overlap with fit indicators associated with the users U3 and U5, and fit indicators associated with the user U2 also overlap with fit indicators associated with the user U1. Determining interrelations and/or conformity and/or similarity between fit indicators associated with the users U3 and U2 and determining interrelations and/or conformity and/or similarity between fit indicators associated with the users U5 and U2 and, respectively, associated with the users U2 and U1 makes it possible to predict indicators of fit of the apparel A2 to the user U1 based on the results of determining and using actual indicators of fit of the apparel A2 to the users U3 and U5. Said interrelations between fit indicators associated with the users U3 and U1 and between fit indicators associated with the users U5 and U1 may be represented in form of a graph 5001, illustrated in FIG. 5A. Each of the nodes of the graph is associated with a set of indicators of fit of various apparels to a certain user, wherein said apparels have designations matching, at least in part, the designation of the selected apparel. An edge of the graph couples two nodes if fit assessments associated with one endpoint of the edge overlap with fit assessments associated with another endpoint. Each edge may be matched with a function F characterizing the interrelation between the fit indicators associated with each of the two endpoints of the edge. An initial node of a graph is defined to be a node that is associated with a set of indicators of fit of apparels to a certain user comprising one or more actual indicators of fit of the selected apparel. The graph may have more than one initial node. A terminal node of the graph is defined to be a node that is associated with a set of indicators of fit of apparels to the selected user. Thus, predicting indicators of fit of an apparel to a user may be represented as a sequence of the following operations: constructing a graph comprising nodes, each of which is associated with indicators of fit of various apparels to a certain user; and edges, each of which couples two nodes if the fit indicators associated with one of the two nodes overlap with fit indicators associated with another node; determining paths from initial nodes to the terminal node; determining functional interrelations and/or conformities and/or similarities between sets of fit indicators associated with each of endpoints of each edge that is a segment of a certain path from determined paths (said functional interrelations may be characterized by said above functions F); predicting said indicators of fit of the apparel to the selected user using fit indicators associated with initial nodes of the graph and said determined functional interrelations and/or conformities and/or similarities. A similarity Simₗᵢ(U_{S}_{ₗ}ᵢ, U_{E}_{ₗ}ᵢ) between a set of indicators of fit of the i-th element of apparels to the user U_{S}_{ₗ} associated with the starting point of the l-th segment of a certain path from determined paths and a set of indicators of fit of the i-th element of apparels to the user U_{E}_{ₗ} associated with the end point of the l-th segment of the same path may be determined similarly to the way described in the embodiment above using equations similar to equations 5 and 6. A conformity Confₗᵢ(U_{S}_{ₗ}ᵢ,U_{E}_{ₗ}ᵢ) between said sets of fit indicators may be determined using, for example, equations similar to equation 6 since the Jaccard index in equation 6 characterizes not only the degree of affinity but also similarity. Having determined similarity and/or conformity between fit indicators associated with the starting point and with the end point of a segment for all segments of the path, it is possible to determine similarity Simₜᵢ(U_{I}_{ₜ}, U_{T}) and/or conformity Confₜᵢ(U_{I}_{ₜ},U_{T}) between indicators of fit of the i-th element of the apparel to the user U_{I}_{ₜ} that are associated with the t-th initial node of the graph and indicators of fit of the i-th element of the apparel to the user U_{F}, that are associated with the terminal node of the graph using, for example, the following equations 7 and 8:

Simₜᵢ(U_{I}_{ₜ},U_{T})=Πₗ₌₁^{s}^{ₜ} Simₗᵢ(U_{S}_{ₗ}ᵢ,U_{E}_{ₗ}ᵢ), [Equation 7]

Confₜᵢ(U_{I}_{ₜ},U_{T})=Πₗ₌₁^{s}^{ₜ} Confₗᵢ(U_{S}_{ₗ}ᵢ,U_{E}_{ₗ}ᵢ), [Equation 8]

wherein sₜ—number of segments of the path from the t-th initial node to the terminal node of the graph.

After having determined similarity and/or conformity between fit indicators associated with initial nodes of the graph and fit indicators associated with the terminal node of the graph, it becomes possible to determine functional interrelation between said fit indicators, in particular, between actual fit indicators associated with initial nodes of the graph and predicting fit indicators associated with the terminal node of the graph. Said functional interrelations may, for example, be determined by equations 2-4.

When fit indicators are expressed in the measures of length (for example, when fit indicators are length fit assessments), a functional interrelation between actual fit indicators associated with a certain initial node of the graph and fit indicators associated with the terminal node of the graph may be determined by using functional interrelations between fit indicators associated with the starting point and end point of a segment for all segments of the path. Said functional interrelations may be determined by the following equation 9:

C_{E}_{ₗ}ⁱ=Fₗⁱ(C_{S}_{ₗ}ⁱ), [Equation 9]

wherein Fₗⁱ—function characterizing interrelation between any of fit indicators C_{S}_{ₗ}ⁱ associated with starting point of the l-th segment of the path with corresponding fit indicator C_{E}_{ₗ}ⁱ associated with end point of the l-th segment of the path; and l—sequential numbers of segments of the path (from 1 to s).

As it was said above, functional interrelations between indicators of fit of an apparel to a user and corresponding indicators of fit of the same apparel to another user stay unchanged for any other indicators of fit of various apparels associated with each of said two users, wherein said fit indicators are expressed in the measures of length and wherein said various apparels have designations matching, at least in part, the designation of said apparel. For example, for length fit assessments said functional interrelations may be determined by the following equation 10:

C_{E}_{ₗ}ⁱ=C_{S}_{ₗ}ⁱ+Δₗⁱ, [Equation 10]

wherein Δₗⁱ—mathematical difference between fit indicator C_{E}_{ₗ}ⁱ and C_{S}_{ₗ}ⁱ.

After having determined said functional interrelations, it becomes possible to determine functional interrelation between a fit indicator C_{I}_{ₜ}ⁱ associated with a starting point of the path and a fit indicator C_{E}ⁱ associated with the end point of the path, which is the terminal node of the graph, determined by the functions Fⁱ=(F₁ⁱ, Fₜⁱ, . . . , Fₛⁱ). To illustrate, let us assume that fit indicators specified in the table 400 are the length fit assessments, then functional interrelations between fit indicators associated with the users U1 and U5 are determined by the value of sums of differences between fit indicators associated with the users U5 and U2 and differences between fit indicators associated with the users U2 and U1. Thus, the function characterizing interrelations between fit indicators C_{U1} and C_{U5} associated with the users U1 and U5, accordingly, is the following: C_{U1}=F(C_{U5})=C_{U5}−Δ, wherein the value of Δ, which is determined by functional interrelation of fit indicators associated with the users U5 and U2, and users U2 and U1, equals −2″=(−1″−2″)+(2″−1″).

Having determined functional interrelation between fit indicators C_{I}_{ₗ}ⁱ and C_{E}ⁱ, respectively associated with starting and end points of the path, using one of the methods described in embodiments above, it becomes possible to predict, with the use of this functional interrelation, indicators of fit of the element of the apparel for the selected individual, for whom an appropriate size of the apparel is being determined. Thus, for the example described above, the value of C_{U1} accordingly equals +1″=−1″−(−2″).

When there are several determined paths from a certain initial node to the terminal node of the graph, only functional interrelations (or functions), conformities, similarities and actual fit indicators, corresponding with the shortest path (associated with the nodes and segments of the shortest path) may be used for fit indicators predicting. Thus, the method described above that is based on collaborative filtering of users with the use of equations 2-6 is a special case of the method described in the present embodiment if fit indicators associated with at least one initial node of the graph have an overlapping with fit indicators associated with the terminal node of the graph.

In the embodiments of the present invention above, a technique of user-based collaborative filtering is applied for predicting fit assessments for the selected article of apparel for the selected individual. Other counterpart embodiments of the present invention use a technique of item-based collaborative filtering, which is similar to a technique of user-based collaborative filtering and where equations similar to equations 2-10 are used. The difference between the techniques is that a user-based collaborative filtering uses a comparison, including determining similarities and functional interrelations, between the fit indicators related to the same apparels but associated with different individuals, while an item-based collaborative filtering uses a comparison between the fit indicators associated with the same individuals but related to different apparels. To illustrate, for the embodiments of the present invention above, the rows of the example table 400 of FIG. 4 are compared in having respective fit indicators, while in the counterpart embodiments a comparison between the columns of the table 400 is used. More precisely, the embodiments above use a comparison between the respective fit assessments included in the 1-st, 2-nd, 3-th and 5-th rows of the table 400, while the counterpart embodiments use a comparison between the respective fit assessments included in all columns. Any person skilled in the art may easily change or modify equations 2-12 and the structure of the graph described above to match with an item-based collaborative filtering technique of the counterpart embodiments of the present invention. To illustrate, in the counterpart embodiments of the present invention, the following equations 2.1 and 6.1 may be used instead of the respective equations 2 and 6 for predicting the fit assessments for the selected article of apparel for the selected individual.

$${PFI}_{{A}_{i}} = \frac{{\sum }_{q = 1}^{z} ( {Sim}_{i} ( {FAS}_{A} , {FAS}_{q} ) \times {AFI}_{{U}_{j} i} )}{{\sum }_{q = 1}^{z} {Sim}_{i} ( {FAS}_{A} , {FAS}_{q} )} , \qquad [ Equation 2.1 ]$$

wherein PFI_{A}_{ᵢ}—predicted indicator of fit of the i-th element Aᵢ of the selected apparel A of the selected size to the selected user Uₚ; Simᵢ(FAS_{A},FAS_{q})—correlation coefficient between actual indicators of fit of the i-th element of the selected apparel A to various users and actual indicators of fit of the i-th element of another apparel to the same various users, wherein said another apparel has a designation matching, at least in part, the designation of the apparel A, and wherein an actual indicator of fit of said another apparel to the selected user is available within the apparel fit advisory service. To illustrate, Simᵢ(FAS_{A},FAS_{q}) may be a correlation coefficient between the actual fit indicators included in the columns of the table 400, wherein each of the compared columns comprises at least one actual fit indicator of an apparel to the selected user); AFI_{U}_{ⱼ}ᵢ—actual indicator of fit of the i-th element Aᵢ of the selected apparel A to the user Uⱼ; i—sequential number (or identifier) of an element of the selected apparel A. In this equation i may take any value within the interval [1, n], wherein n—number of elements of the selected apparel A; q—sequential number or a designation of an apparel to which a related actual fit indicator associated with the selected user is available within the apparel fit advisory service, said apparel matching, at least in part, the designation of the selected apparel A; q consecutively takes values from the interval [1, z], wherein z—number of designations to which related actual fit indicators are used for predicting PFI_{A}_{ᵢ}. The apparel fit advisory service may take for z the number of all designations of apparels for which related actual fit indicators associated with the selected user are available within the apparel fit advisory service or only a part of said designations that are included in the selected list of designations (as described in another embodiment below).

The term “overlap”, as applied to fit indicators related to two designations, means that there is at least one indicator of fit of the respective at least one element related to one designation to a user and there is at least one indicator of fit of the same at least one element related to another designation to the same user. Alternatively, overlap means that there is at least one indicator of fit related to one designation to a user and there is at least one indicator of fit related to another designation to the same user if the fit indicators are related to the respective articles of apparel as a whole (but not to individual elements of the respective articles of apparel). For notation, an “overlap of fit indicators related to designations” may be referred to as “overlap between the designations”, wherein two or more designations overlap with each other if the respective sets of fit indicators related to these designations and associated with the same users have mutual overlaps.

The correlation coefficient Simᵢ(Uₚ,Uⱼ) in equation 2.1 may be determined, for example, as a Jaccard index and may be represented by the following equation 6.1:

$${Sim}_{i} ( {FAS}_{A} , {FAS}_{q} ) = \frac{Count ( {FAS}_{A} ⋂ {FAS}_{q} )}{Count ( {FAS}_{A} ⋃ {FAS}_{q} )} \times \frac{Count ( {FAS}_{A} ⋂ {FAS}_{q} )}{Count ( {FAS}_{A} )} , \qquad [ Equation 6.1 ]$$

wherein Count(FAS_{A} ∩ FAS_{q})—function returning the number of actual fit indicators comprising the set that is an intersection of two following sets: a set of indicators of fit of the i-th element of the selected apparel A to various users and a set of indicators of fit of the i-th element of the apparel q to the same various users, wherein the apparel q has a designation matching, at least in part, the designation of the selected apparel A (i.e., Count(FAS_{A} ∩ FAS_{q})—function returning the number of overlapped fit indicators of the two sets of fit indicators related to the selected apparel A and to the apparel q, respectively); Count(FAS_{A} ∪ FAS_{q})—function returning the number of actual fit indicators comprising the set that is a union of the two said sets accordingly related to the selected apparel A and to the apparel q; Count(FAS_{A})—function returning the number of fit indicators in the set of fit indicators related to the selected apparel A.

In the capacity of correlation coefficients Simᵢ(FAS_{A}, FAS_{q}) may also be used, but are not limited to, Kendall or Pearson correlation coefficients.

In the counterpart embodiments of the present invention, the graph 5001 in FIG. 5A is substituted by the graph 5002 in FIG. 5B. The graph 5002 represents the interrelations between the fit indicators related to the selected apparel A2 associated with the users U1-U5 and the respective fit indicators related to the other apparels in the table 400. Each of the nodes of the graph is associated with a set of indicators associated with various users and related to a certain apparel of a certain size, wherein all designations associated with the nodes of the graph match, at least in part, the designation of the selected apparel, and wherein one of the nodes of the graph is associated with the selected apparel. An edge of the graph couples two nodes if fit assessments associated with one endpoint of the edge overlap with fit assessments associated with another endpoint. Each edge may be matched with a function F* characterizing the interrelation between the fit indicators associated with each of the two endpoints of the edge. An initial node of a graph is defined to be a node that is associated with an apparel of a certain model and size for which a related set of fit indicators comprises an actual indicator of fit associated with the selected user. The graph may have more than one initial node. A terminal node of the graph is defined to be a node that is associated with the selected apparel of a certain size. The graph may have more than one terminal node. Thus, predicting indicators of fit of an apparel to a user may be represented as a sequence of the following operations: constructing a graph comprising nodes, each of which is associated with indicators of fit of a certain apparel to various users; and edges, each of which couples two nodes if the fit indicators associated with one of the two nodes overlap with fit indicators associated with another node; determining paths from the initial nodes to the terminal nodes; determining functional interrelations and/or conformities and/or similarities between sets of fit indicators associated with each of endpoints of each edge that is a segment of a certain path from determined paths (said functional interrelations may be characterized by said above functions F*); predicting said indicators of fit of the apparel to said user using fit indicators associated with initial nodes of the graph and said determined functional interrelations and/or conformities and/or similarities. A similarity Simₗᵢ(D_{S}_{ₗ}ᵢ,D_{E}_{ₗ}ᵢ) between a set of indicators of fit of the i-th element of an apparel having the designation D_{S}_{ₗ} associated with the starting point of the l-th segment of a certain path from determined paths and a set of indicators of fit of the i-th element of an apparel having the designation D_{E}_{ₗ} associated with the end point of the l-th segment of the same path may be determined using equations similar to equation 6.1. A conformity Confₗᵢ(D_{S}_{ₗ}ᵢ,D_{E}_{ₗ}ᵢ) between said sets of fit indicators may be determined using, for example, an equation similar to equation 6.1 since the Jaccard index in equation 6.1 characterizes not only the degree of affinity but also similarity. Having determined similarity and/or conformity between fit indicators associated with the starting point and with the end point of a segment for all segments of the path, it is possible to determine similarity Simₜᵢ(D_{I}_{ₜ},D_{T}_{_{f}}) and/or conformity Confₜᵢ(D_{I}_{ₜ},D_{T}_{_{f}}) between indicators of fit of the i-th element of the apparel having the designation D_{I}_{ₜ} that is associated with the t-th initial node of the graph and indicators of fit of the i-th element of the apparel having the designation D_{T}_{_{f}} that is associated with the f-th terminal node of the graph using, for example, the following equations 7.1 and 8.1:

$$\begin{matrix}{Sim}_{ti} ( {U}_{{l}_{t}} , {U}_{{T}_{f}} ) = {\prod }_{l = 1}^{{s}_{{t}_{f}}} {Sim}_{li} ( {D}_{{S}_{l} i} , {D}_{{E}_{l} i} ) , & [ Equation 7.1 ] \\ {Conf}_{ti} ( {U}_{{l}_{t}} , {U}_{{T}_{f}} ) = {\prod }_{l = 1}^{{s}_{{t}_{f}}} {Conf}_{li} ( {D}_{{S}_{l} i} , {D}_{{E}_{l } i} ) , & [ Equation 8.1 ]\end{matrix}$$

wherein sₜ_{_{f}}—number of segments of the path from the t-th initial node to the f-th terminal node of the graph.

After having determined similarity and/or conformity between fit indicators associated with initial nodes of the graph and fit indicators associated with the terminal nodes of the graph, it becomes possible to determine functional interrelation between said fit indicators, in particular, between actual fit indicators associated with initial nodes of the graph and predicting fit indicators associated with the terminal nodes of the graph. Said functional interrelations may, for example, be determined by equations 2.1 and 6.1. Having determined functional interrelations between fit indicators respectively associated with starting and end points of the path, it becomes possible to predict, with the use of these functional interrelations, indicators of fit of the element of the selected apparel for the selected individual for each of the sizes associated with the initial nodes of the graph.

For various embodiments of the present invention, it is possible to apply a function, a combination or a transformation to several predicted fit indicators corresponding with the same element of the selected apparel or with the selected apparel as a whole to convert these original fit indicators to one integral fit indicator, and then the integral fit indicator may be used instead of the respective original fit indicators for determining the appropriate size of the selected apparel. Each of the original fit indicators may be predicted using one of the techniques of item-based and user-based collaborative filtering described above or any combination thereof. Such conversion may be applied to ensure higher accuracy when predicting the appropriate size of the selected apparel. To illustrate, an averaging may be applied to several original fit indicators predicted with the use of functional interrelations (or functions) and/or conformities and/or similarities and actual fit indicators corresponding with various determined paths of the graph to obtain the resultant average fit indicator. In the capacity of predicted average fit indicator one may use arithmetical mean, power mean, mode and median values of predicted original fit indicators, each of which corresponds with a certain path in the graph and all of which indicate fit of the same element of the apparel the appropriate size of which is being determined. Hereinafter, referring to a fit indicator, it is assumed that the fit indicator may be an original fit indicator as well as an integral fit indicator, and there is no difference in their further use.

For various embodiments of the present invention, when predicting indicators of fit of the selected apparel to the selected user, data (information) may be adjusted or corrected before using it for determining an appropriate size of an apparel to ensure higher accuracy in predicting fit indicators. To illustrate, in comparing fit assessments given by two users to articles of apparels of the same designation and size, fit assessments associated with at least one of the two users may be adjusted (corrected) if the articles assessed by the first and the second users differ in at least one of their measurements so the fit assessments associated with each of the two users become related (pertain) to the article having the same measurements for both users. Assessed articles of apparel of a certain designation and size may have differing measurements for various assessors by, for example, the reason of being assessed at different conditions of use, i.e. one article of apparel may be assessed right after or at buying, while some others may be assessed after some use and some washings and other treatments so the material of an article may have stretched or shrank versus the new article, and an assessment of the new article by the owner may change after some wearing. Thus, the adjustment (correction) of fit indicators, being performed at comparing or after their receiving, should take into account possible changes of measurements of the assessed apparel and/or possible difference between assessed apparels of the same designation and size. The adjustment (correction) may factor in, but is not limited to, the following apparels' characteristics: date of assessment, purchase date, usage time (period of wearing), usage intensity, number and intensities of washings and other treatments, wear, properties of the material of apparels, such as fabric content, density of the fabric, fabric shrinkage or stretching properties after wearing and/or washings and other, and so on. The adjustment (correction) may be applied, for example, in a form of “weights” to each of the fit assessments available within the apparel fit advisory service. To illustrate, in comparing two respective length fit assessments related to the same element of two articles of an apparel of the same designation and size, wherein the first fit assessment relates to the first article that is new, and the second fit assessment relates to the second article which is used and for which an assessed element became looser by 0.5″, then the second fit assessment may be changed by the “weight” 0.5″ to become comparable with the first one. Each “weight” may be applied to each of the fit indicators used in the equations 1-12. At least some of data related to apparels' characteristics used for the adjustment (correction) may be provided by the requester in the request 130 or be derived from the requesting user purchasing history 124 and/or profile 126. Properties of the material of apparels, such as fabric content, density of the fabric, fabric shrinkage or stretching properties after wearing and/or washings and other, etc. may be derived from apparels' profiles 122, data in the profiles being provided and updated by the manufacturers.

In various embodiments of the present invention, when predicting indicators of fit of the selected apparel to the selected user, data (information) may be used which relates to all users or to only a part of all users that tried on apparels having designations matching, at least in part, the designation of the selected apparel. Thus, the apparel fit advisory service may generate a list of users with whom associated fit indicators are used for predicting fit indicators associated with the selected user. Hereinafter such a list is referred as a selected list of users. Such a list is herein referred as a selected list of users. A selected list of users may be generated to ensure higher accuracy in predicting fit indicators. Selection of users to be included in the list may be based on various criteria. One of them may be similarity between the respective measurements of assessed by the users, being included in the selected list of users, articles of apparels of the same designation and size, which may further involve, as described in the embodiment above, similarity in such characteristics of the respective assessed articles as date of assessment, purchase date, usage time (period of wearing), usage intensity, number and intensities of washings and other treatments, wear of the respective articles, and so on. Another criterion may be similarity, at the time close to the time of assessing respective apparels and/or on the date of providing size recommendations, between anthropometric parameters (e.g., weight or height), physical proportions of bodies of users that had tried on apparels having designations matching, at least in part, the designation of the selected apparel the appropriate size of which is to be determined and of the selected user. Still another criterion may be conformity and/or similarity between actual fit indicators and/or fit preferences associated with other users and fit indicators and/or fit preferences associated with the selected user. Thus, to ensure higher accuracy when predicting fit indicators of the selected apparel to the selected individual using equations 2-4, the apparel fit advisory service may not utilize fit indicators of apparels associated with other users if conformity and/or similarity between fit indicators and/or fit preferences associated with those other users and fit indicators and/or fit preferences associated with the requesting user is lower than a selected threshold value, for example, smaller than 0.85. When predicting indicators of fit of the selected apparel to the selected user, the apparel fit advisory service may use information only on those actual fit indicators associated with another user having similarity and/or conformity with the actual fit indicators associated with the selected user equals 1.0, i.e., exactly coincide with ones of the selected user. Other criteria may be used apart or together to generate selected lists of users.

In various embodiments of the present invention, when predicting indicators of fit of the selected apparel for the selected user, data (information) may be used which relates to all apparels or to only a part of all apparels having designations matching, at least in part, the designation of the selected apparel. Thus, the apparel fit advisory service may generate a list of apparels to which related fit indicators are used for predicting fit indicators associated with the selected user. Such a list is herein referred as a selected list of apparels. A selected list of apparels may be generated to ensure higher accuracy in predicting fit indicators. Selection of apparels to be included in the list may be based on various criteria. One of them may be similarity between the respective measurements of articles of apparels of the same designation and size, being included in the selected list of apparels, which may further involve, as described in the embodiment above, similarity in such characteristics of the respective articles as date of assessment, purchase date, usage time (period of wearing), usage intensity, number and intensities of washings and other treatments, wear of the respective articles, and so on. Another criterion may be conformity and/or similarity between actual fit indicators associated with various users and related to the selected apparel of a certain size and the respective fit indicators related to apparels having designations matching, at list in part, the designation of the selected apparel. Thus, to ensure higher accuracy when predicting fit indicators of the selected apparel for the selected individual using the equations of the counterpart embodiments of the present invention, the apparel fit advisory service may not utilize fit indicators related to various apparels if conformity and/or similarity between fit indicators related to those various apparels and fit indicators related to the selected apparel is lower than a selected threshold value, for example, smaller than 0.85. Other criteria may be used apart or together to generate selected lists of designations.

For various embodiments of the present invention, when predicting fit indicators is based on determining functional interrelations between fit indicators associated with each of endpoints of the segments for all determined paths of the graph, the apparel fit advisory service, in order to exclude possible inaccurate fit indicators related to nodes of paths, may control the linearity of functional interrelations between fit indicators for each of the segments and exclude those paths for one or more segments of which conformity and/or similarity between fit indicators related to endpoints of segments is lower than a selected threshold value, for example, smaller than 0.95.

For various embodiments of the present invention, when predicting fit indicators of the selected apparel for the selected user, a preferred apparel fit advisory service may determine fit indicators of missing sizes of the selected apparel based on fit indicators that have already been predicted for other sizes of apparels that are of the same model as the selected apparel or that is at least of the same brand and style as the selected apparel. Hereinafter missing sizes of an apparel means those sizes of the apparel for which fit indicators were impossible to predict using methods described above, and available sizes of an apparel means those sizes of the apparel for which fit indicators can be predicted using methods described above. To illustrate, if a manufacturer produces jeans of a selected model having waist sizes of: 28, 29, . . . , 36, 38, . . . , 58, 60 and information required for predicting fit indicators of the jeans of all sizes except sizes 32 and 38 is available within the apparel fit advisory service, the fit indicators of the jeans of all sizes except sizes 32 and 38 may be predicted as described above and then the fit indicators of the jeans of the missing sizes 32 and 38 may be determined based on rules of changes of characteristics of and/or predicted or actual fit indicators related to the articles of jeans from one size to another. These rules may be received from the manufacturer or may be identified as functional interrelations by the apparel fit advisory service. For example, the functional interrelation may be the following: waist measurement of the jeans increases by 1″ from one size to another one in the range of sizes 28-36 and by 2″ in the range of sizes 36-60. Once functional interrelations have been identified, the apparel fit advisory service may predict fit indicators related to the apparel of missing sizes using fit indicators related to the apparel of available sizes. Hereby, in the example above, waist fit indicators related to the jeans of sizes 32 and 38 may be determined using information on waist fit indicators already predicted that relate to the jeans of any of the available sizes, for instance, ones related to the size 30. If a waist fit indicator denominated in the measures of length related to the jeans of size 30 equals 1¼″, then waist fit indicator related to the jeans of size 32 equals 1¼″+2×1″=3¼″ and waist fit indicator related to the jeans of size 38 equals 1¼″+6×1″+1×2″=9¼″. If in the example abovethe waist fit indicators related to the jeans of waist of sizes 32 and 38 are missing but also the information on fit indicators related to the jeans of waist of sizes 28-31 and 40-60, i.e., the information on waist fit indicators related to the jeans is not sufficient for identification of said functional interrelation, then the apparel fit advisory service may also use information on waist fit indicator related to jeans of other models of the same manufacturer that are at least of the same style as said jeans and that are produced or were produced under the same standard of cut. The likelihood of correctness of determining fit indicators related to a missing apparel size may be determined based on previously determined likelihoods of correctness of determining one or more available sizes of the apparel as described below and/or based on the trustworthiness of determining the above interrelations, which may be characterized, for example, by conformities of characteristics of the apparel of each of all available sizes. Any person skilled in the art may easily apply existing or develop new methods of determining said functional interrelations and said likelihoods.

For various embodiments of the present invention, to reduce computing load, either the requesting user may specify or the apparel fit advisory service may determine a selected list of sizes, so indicators of fit of the apparel to the requesting user will be predicted only for those sizes of the apparel that are included in the selected list of sizes, and the appropriate size of the apparel will be accordingly determined only among of apparel sizes in the selected list. The apparel fit advisory service may determine the selected list of sizes based, for example, on the requesting user's purchasing history and/or based on the requesting user's anthropometric parameters and/or based on purchasing histories and/or anthropometric parameters and/or fit preferences of other users, who may be included in the selected list of users described above. For example, if the user has a 30″ waist and there is another user who has a similar waist measurement (for example, 30.5″) and/or the respective fit preference and who had purchased jeans of waist sizes 30-31 that have, according the user's assessment, a proper fit to the user, then the apparel fit advisory service may predict fit indicators related only to the jeans of waist sizes close to the sizes 30-31, which may be taken as a “central size”, so the apparel fit advisory service may predict fit indicators related only to the jeans of waist sizes 28-34 as ranging from the “central size” within a selected value and as having been adjusted (corrected) by factoring in a difference in the respective anthropometric parameters and/or fit preferences since jeans beyond this range of sizes will surely not fit the user.

In alternate embodiments of the present invention, to reduce computing load, the apparel fit advisory service may start predicting fit indicators related to an apparel, an appropriate size of which is to be determined alternatively for apparels having sizes greater and smaller than the size of an apparel having a perfect fit to the user, wherein said apparels have designations matching, at least in part, the designation of the apparel for which an appropriate size is to be determined. If in the course of such predicting it appears that an indicator of fit of a certain element of the apparel of a certain size is greater, and an indicator of fit of the same element of the apparel of another size is smaller than the fit indicator compliant with the proper fit of the element of the apparel to individuals, then the apparel fit advisory service may limit the predicting of fit indicators related only to the elements of the apparel of sizes within a range of the greater and smaller sizes of the apparel.

For various embodiments of the present invention, the apparel fit advisory service may recommend to the selected user the selected apparel of a certain one or more sizes for which the predicted fit indicators are exactly equal or are the closest to the fit indicators compliant with the proper fit of apparels to individuals. Alternatively, the apparel fit advisory service may perform a comparison within the respective predicted fit indicators related to various sizes of the selected apparel and then provide apparel size recommendations based on results of the comparison. To illustrate, the selected user may know for sure that one of several sizes of the selected apparel will fit him/her well. In such case, the selected user may additionally provide to the apparel fit advisory service the selected list of sizes (one out of these sizes will fit the selected user as he/she knows), and the apparel fit advisory service then predicts the fit indicators for each size from the received selected list of sizes with a subsequent comparison within the respective predicted fit indicators to recommend that size of the selected apparel related to which fit indicators are minimum (or maximum—depending on the given scale of fit assessments).

In various embodiments of the present invention, determining an appropriate size of the selected apparel and providing apparel recommendations may factor in a likelihood of correctness of determining an appropriate size of the selected apparel. The above threshold values of conformities and/or similarities, which are used for generating selected lists of users and/or selected list of designations, or their combinations and/or functions, which arguments are said thresholds, may characterize the likelihood of correctness of determining appropriate sizes of the selected apparel. To illustrate, if fit indicators of the selected apparel associated with the selected user are predicted based on fit indicators associated with other users included in the selected list of users, then the likelihood of correctness of determining an appropriate size of the apparel may be characterized by the result of multiplication of similarities and/or conformities corresponding with each of the consecutive segments of a path from the initial node to the terminal node of the graph. Also, one may use various types of means (such as arithmetical mean, power mean, etc.) of said similarities and/or conformities in the capacity of a likelihood. Any person skilled in the art may easily chose or develop other measures characterizing likelihoods of correctness of determining of appropriate sizes of apparels. These include, but are not limited to using Spearman coefficients of similarities and Jaccard indexes.

In alternate embodiments of the present invention, determining an appropriate size of the selected apparel and providing apparel recommendations may factor in a likelihood of correctness of a complete fit of the selected apparel of the determined size to the selected user. The value of said likelihood is characterized by the similarity between predicted fit indicators related to the determined size of the selected apparel and fit indicators compliant with the proper fit of apparels to individuals. In the capacity of said likelihood one may use a Jaccard index determined by the following equation 11:

$$\begin{matrix}{P}_{k} = Sim ( {PFI}_{{S}_{k}} , {FI}_{O} ) \\ = \frac{{\sum }_{i = 1}^{m} {PFI}_{{S}_{k} i} \times {FI}_{O}}{{\sum }_{i = 1}^{m} {( {PFI}_{{S}_{k} i} )}^{2} + {\sum }_{i = 1}^{m} {( {FI}_{O} )}^{2} - {\sum }_{i = 1}^{m} {( {PFI}_{{S}_{k} i} \times {FI}_{O} )}^{′}}\end{matrix} \qquad [ Equation 11 ]$$

wherein Pₖ—likelihood of complete fit of the selected apparel of size k to the user; PFI_{S}_{ₖ}—set of predicted fit indicators related to the selected apparel of size k, wherein each indicator PFI_{S}_{ₖ}ᵢ of the set is predicted indicator of fit of the i-th element of the apparel of size k to the selected user; FI_{O}—fit indicators compliant with the proper fit of apparels to individuals; m—the number of elements of the selected apparel.

Thus, for various embodiments of the present invention, the apparel fit advisory service may provide to a user apparel recommendations that factor in a likelihood of correctness of determining an appropriate size of the apparel and/or a likelihood of correctness of complete fit of the apparel of the determined size to the user. For various embodiments of the present invention, the apparel fit advisory service may recommend to a user an apparel of that certain one or more sizes related to which the likelihood of correctness of determining appropriate sizes of the apparel and/or likelihood of correctness of complete fit of the apparel of the determined sizes to the user are the greatest.

For various embodiments of the present invention, the apparel fit advisory service may provide apparel recommendations that factor in relevancies of appropriate fit of each element of the apparel to the individual's physical body. An individual or initiator of the request 130 may specify, or the apparel fit advisory service may automatically preset, the value of relevance of appropriate fit of each dimension of the apparel to the individual's physical body. Said values of relevancies may be automatically preset by the apparel fit advisory service for each apparel dimension based on the history of ranking the relevancies of dimensions of various apparels having designations matching, at least in part, the designation of the apparel the appropriate size of which is to be determined specified by the apparel fit advisory service users. The apparel fit advisory service may convert relevancies of elements of an apparel provided by a user to a numerical format and apply normalization to them in a way that the sum of said relevancies of all elements of the apparel equals 1. Then, the values of relevancies may be factored in as “weights” at determining the likelihood of correctness of complete fit of the apparel of the determined size. To illustrate, likelihoods of correctness of fit of various elements of the selected apparel of a certain size to a user may be determined by the following equation 12 (which is a modification of equation 11) that factors in said values of relevancies:

$$\begin{matrix}{P}_{k} = Sim ( {PFI}_{{S}_{k}} , {FI}_{O} ) \\ = \frac{{\sum }_{i = 1}^{m} {PFI}_{{S}_{k} i} \times {FI}_{O} \times {w}_{i}}{\begin{matrix}{\sum }_{i = 1}^{m} {( {PFI}_{{S}_{k} i} \times {w}_{i} )}^{2} + {\sum }_{i = 1}^{m} {( {FI}_{O} \times {w}_{i} )}^{2} - \\ {\sum }_{i = 1}^{m} {( {PFI}_{{S}_{k} i} \times {FI}_{O} \times {w}_{i} )}^{′}\end{matrix}}\end{matrix} \qquad [ Equation 12 ]$$

wherein wᵢ—the “weight” associated with the i-th element of the selected apparel, wherein the “weight” is the relevance of appropriate fit of the i-th element of the selected apparel.

Having determined likelihoods of correctness of fit of each element to a user for each size of the selected apparel from the selected list of sizes, the apparel fit advisory service may, as it was said above, recommend to the user the selected apparel of that certain one or more sizes related to which likelihood of correctness is the greatest.

For various embodiments of the present invention, predicting 206 makes available the sets of said predicted fit indicators, wherein each set relates to a certain size of the selected apparel, and each of the fit indicators in the set corresponds with a certain element of the selected apparel. To illustrate, the sets of predicted fit indicators related to jeans may comprise series of fit indicators, wherein each of the series relates to a specific size of the jeans and each of the fit indicators in the set corresponds with a certain element of the jeans. For example, the sets of predicted fit indicators for jeans may comprise series of fit indicators related to the following elements of jeans: waist, inseam, rise, leg opening.

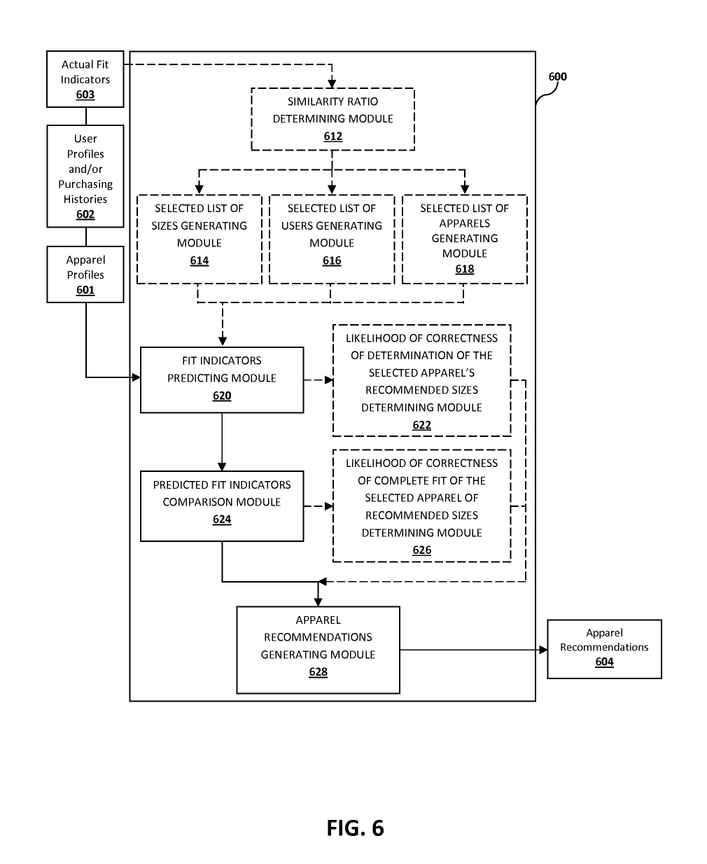

FIG. 6 illustrates a logical scheme of interactions of modules of a device of the apparel fit advisory service that is adapted to provide apparel size recommendations, in accordance with various embodiments of the present invention. As illustrated in FIG. 6, the unit 600, which may be a server of the apparel fit advisory service or a part of the server or a user's device or a part of the user's device, is adapted to provide apparel size recommendations 604 for a selected apparel for a selected user based on actual fit indicators 601 of the apparel of various sizes associated with various users and possibly based on data stored in the profile of the selected user and/or in the profiles and/or purchasing histories 602 of the other users and stored in the profile 603 of the selected apparel and/or in the profiles 603 of other apparel. The unit 600 may incorporate the following modules: a module 612 for determining similarity ratios, a module 614 for generating a selected list of sizes, a module 616 for generating a selected list of users, a module 618 for generating a selected list of apparels, a module 620 for predicting fit indicators, a module 622 for determining the likelihood of correctness of the determination of the selected apparel's sizes being recommended to the selected user, a module 624 for comparing predicted fit indicators, a module 626 for determining the likelihood of correctness of complete fit of the selected apparel for various determined sizes, and an apparel recommendations generating module 628. The availability of the modules 620, 624 and 628 enables the functionality of the unit 600. The modules 612-618, 622, 626 are not necessary for the functionality of the unit 600. Contours of these modules are illustrated in FIG. 6 with dashed lines. The module 614 is required for functionality of the unit 600 if fit indicators are expressed as measures of length. Information transmitted to the unit 600 comprises actual fit indicators 601 of various apparels associated with the selected user, and also contains actual fit indicators 601 of various apparels associated with other users, wherein said various apparels have designations matching, at least in part, the designation of the selected apparel.

The module 612 determines conformities and/or similarities between fit indicators associated with the selected user and the other users and/or between data stored in the profiles 601 of the selected apparel and the other apparels and in the profiles and purchasing histories 602 of the selected user and the other users.

The module 614 generates a selected list of sizes based on information on actual fit indicators 603 associated with the selected user and/or associated with the other users and/or based on data stored in the profiles 601 of the selected apparel and the other apparels and in the profiles and purchasing histories 602 of the selected user and the other users and based on the conformities and/or similarities determined by the module 612 between the respective data used by the module 614. As it is illustrated in FIG. 6, the data stored in the profiles 601 of the selected apparel and the other apparels and in the profiles and purchasing histories 602 of the selected user and the other users should be also transmitted to the unit 600 if they are used for generating the selected list of sizes. For each size included in the selected list of sizes the indicators of fit of the selected apparel to the selected user will be predicted by the module 620. The fit of the selected apparel of sizes out of the selected list of sizes deliberately will not fit the selected user, so it is unnecessary that the module 620 to predict fit indicators related to the selected apparel of these sizes.

The module 616 generates the selected list of users based on the same information and data that the module 614 uses. For each user included in the selected list of users only the fit indicators associated with the included user will be used by the module 620.

The module 618 generates the selected list of apparels based on the same information and data that the module 614 uses. For each apparel included in the selected list of apparels only the fit indicators related to the included apparel will be used by the module 620.

The module 620 predicts indicators of fit of the apparel to the selected user, for each of the sizes of the selected apparel being produced or were produced or only for the sizes included in the selected list of sizes generated by the module 614, using actual fit indicators 601 associated with the user and the other users, or only associated with the users included in the selected list of users generated by the module 616 and/or related to apparels included in the selected list of apparels generated by the module 618.

The module 622 determines the likelihoods of correctness of the determination of the selected apparel's sizes being recommended to the selected user based on the values of the conformities and/or similarities determined by the module 612.

The module 624 compares a set of the fit indicators predicted for a certain size of the selected apparel with the respective set of fit indicators compliant with the proper fit of apparels to individuals and/or compares the respective sets of the fit indicators predicted for several sizes of the selected apparel with each other. The fit indicators comparison module 624 may also determine the similarity between any of the compared sets for each of the predicted sizes of the selected apparel.

The module 626 determines the likelihoods of complete fit of the selected apparel for various determined sizes based on the values of similarities determined by the module 612.

The module 628 generates apparel recommendations 604 based on the results of the comparison processed by the unit 624, with or without factoring in the likelihoods of correctness of the determination of the selected apparel's sizes being recommended to the selected user determined by the module 622 and/or the likelihoods of complete fit of the selected apparel for various determined sizes determined by the module 626.

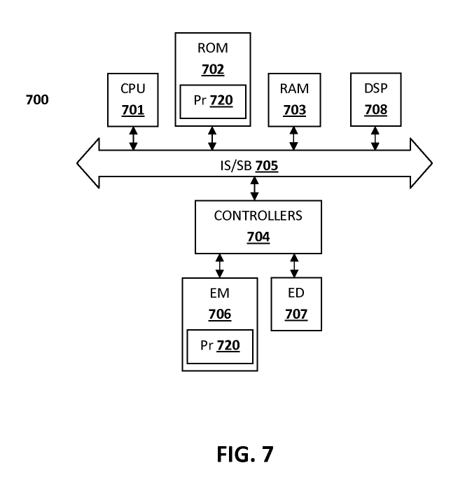

FIG. 7 depicts a possible architecture 700 of the devices 102-106 and of any combinations of the devices 102-106, in accordance with various embodiments of the present invention. As illustrated in FIG. 7, the devices 102-106 and of any combinations of the devices 102-106 may comprise the following components performing the same functions as they usually perform in computing devices: microprocessor or microcontroller (CPU) 701; non-volatile memory (i.e., ROM) 702; random access memory (RAM) 703; controllers 704; interface system or system bus (IS/SB) 705, which couples components 701-704; external memory (EM) 706, which may comprise mass storage—data storage (disc arrays such as RAID) that may comprise data 122 and/or 124 and/or 126; external devices (ED) 707, which may comprise input-output and other peripheral devices and communication devices including those for communicating with other user devices, business servers and apparel fit advisory service servers. Any of the devices 102-106 and of any combinations of the devices 102-106 may also incorporate a digital signal processor (DSP) 708, one of the functions of which is converting a user's fit assessments in a non-digital format into a digital one supported by the user device. If a DSP is not incorporated into the devices 102-106 or to any combinations of the devices 102-106, it may be a part of an external device (ED) and implement the same functions. Various devices for inputting data related to apparel which the user has (scanners, etc.), may also be a part of the external devices (ED). Non-volatile memory 702, external memory 706, or external devices 707 may contain a program 720 operated by the microprocessor or microcontroller 701 that implements an algorithm 200 for predicting an appropriate size of an apparel and for providing apparel size recommendations. The program 720 may be written via a variety of programming languages including, but not limited to, XML, Java, Visual J++, C, C++, Visual Basic and others. The program 720 may also comprise implementations of other functions that are not included in the algorithm 200, or those functions may be implemented with the use of other programs or devices. For example, functions of establishing communication and data exchange between the apparel fit advisory service servers and other devices may be implemented in a form of program implemented by a dedicated communication server of the apparel fit advisory service. Another example is that utilities of a user's interface support may be implemented in a form of a program uploaded in and processed by any of the devices 102-106. The devices 102-106 may also comprise software, firmware and hardware elements and modules well known in computing devices and electronic industry and telecommunication for apparel fit advisory services functioning.

Any part of the present invention or the invention as a whole may be implemented in software, firmware, hardware or combination thereof, for example, in a form of Erasable Programmable Logic Devices (EPLD) or Field Programmable Gate Arrays (FPGA), and so on.

It is to be understood that any variants of considered possibilities of practical implementation including one with the use of devices with an architecture 700 may comprise elements omitted in the present description with the aim of clear and short description and may be changed or modified by those skilled in the art for more precise conformity between the apparel fit advisory service realization and a contemporary state of the art.

Furthermore, other areas of art may benefit from this method and adjustments to the design are anticipated. Thus, the scope of the invention should be determined by the appended claims and their legal equivalents, rather than by the examples given.

1) A method of providing for a selected individual at least one size recommendation for a selected article of apparel, the method comprising the steps of:
a) providing a reference data set comprising a plurality of reference records, each reference record comprising an identity of an individual, a respective designation for a respective article of apparel, an associated size of the respective article of apparel and an associated fit assessment comprising a respective value assigned to the respective article of apparel;
b) receiving a designation of the selected article of apparel;
c) receiving at least one record associated with the selected individual, each record associated with the selected individual comprising a respective designation for a respective article of apparel of at least the same style and type as the selected article of apparel, an associated size of the respective article of apparel and an associated fit assessment comprising a respective value assigned to the respective article of apparel;
d) defining a subset of the reference data set comprising reference records for individuals associated with at least one article of apparel of at least the same style and type as the selected article of apparel wherein at least one reference record in the subset comprises a respective designation corresponding to that of the selected article of apparel; and
e) providing the at least one size recommendation based on at least one fit assessment from the at least one record associated with the selected individual and at least one fit assessment from the defined subset.

2) The method of claim 1 further comprising providing a plurality of the size recommendations for a plurality of the selected articles of apparel.

3) The method of claim 1 wherein at least one of the reference records further comprises at least one respective apparel element associated with the respective article of apparel.

4) The method of claim 1 wherein at least one fit assessment comprises a respective numerical value assigned to the respective article of apparel by the individual associated therewith.

5) The method of claim 1 wherein at least one of the fit assessments is calculated using individual profile data.

6) The method of claim 1 wherein at least one of the fit assessments is calculated using apparel profile data.

7) The method of claim 1 wherein the defined steps are carried out by at least one server apparatus, and wherein the designation of the selected article of apparel and the at least one record associated with the selected individual are transmitted over a network from at least one client apparatus associated with the selected individual.

8) The method of claim 1 initiated by transmitting a request over a peer-to-peer network comprising a plurality of computing devices jointly operable, responsive to the request, to carry out the steps of providing the reference data set, receiving the designation, receiving the at least one record, defining the subset, and providing the size recommendation.

9) The method of claim 1 wherein the step of providing the size recommendation comprises the substeps of:
e1) supplementing the defined subset by the at least one record associated with the selected individual; and
e2) comparing fit assessments of the records in the supplemented subset.

10) The method of claim 1 wherein the step of providing the size recommendation comprises the substeps of:
e1) supplementing the defined subset by the at least one record associated with the selected individual;
e2) comparing fit preferences of the records in the supplemented subset.

11) A method of providing for a selected individual at least one size recommendation for a selected article of apparel, the method comprising the steps of:
a) providing a reference data set comprising a plurality of reference records, each reference record comprising an identity of an individual, a respective designation for a respective article of apparel, an associated size of the respective article of apparel and an associated fit assessment comprising a respective value assigned to the respective article of apparel;
b) receiving a designation of the selected article of apparel;
c) receiving at least one record associated with the selected individual, each record associated with the selected individual comprising a respective designation for a respective article of apparel of at least the same style and type as the selected article of apparel, an associated size of the respective article of apparel and an associated fit assessment comprising a respective value assigned to the respective article of apparel;
d) defining a subset of the reference data set comprising reference records for individuals associated with at least one article of apparel of at least the same style and type as the selected article of apparel wherein at least one reference record in the subset comprises a respective designation corresponding to that of the selected article of apparel; and
e) predicting for the selected individual at least one fit assessment for at least one size of the selected article of apparel based on at least one fit assessment from the at least one record associated with the selected individual and at least one fit assessment from the defined subset; and
f) providing the at least one size recommendation based on the at least one predicted fit assessment.

12) A method of providing for a selected individual a size recommendation for a selected article of apparel, the method comprising the steps of:
a) providing a reference data set comprising a plurality of reference records, each reference record comprising an identity of an individual; a respective set of designations, each designation being uniquely associated with a respective article of apparel; a respective associated set of sizes of the respective designated articles of apparel; and a respective associated set of fit assessments, each fit assessment comprising at least one respective value assigned to the respective associated designated article of apparel;
b) receiving a designation of the selected article of apparel;
c) receiving at least one record associated with the selected individual, each record associated with the selected individual comprising a respective set of designations, each designation being uniquely associated with a respective article of apparel other than the selected article of apparel; a respective associated set of sizes of the respective designated articles of apparel; and a respective associated set of fit assessments, each fit assessment comprising at least one respective value assigned to the respective associated designated articles of apparel;
d) defining a subset of the reference data set comprising reference records for individuals associated with at least one article of apparel of at least the same style and type as the selected article of apparel wherein at least one reference record in the subset comprises a respective designation corresponding to that of the selected article of apparel;
e) comparing the sets of fit assessments of the records in the defined subset and of the at least one record associated with the selected individual to determine at least one predicted fit assessment for at least one size of the selected article of apparel; and
f) providing the size recommendation based on the at least one predicted fit assessment.

13) The method of claim 12 wherein the step of providing the size recommendation further comprises comparing respective fit assessments predicted for two different sizes.

14) The method of claim 12 wherein the step of providing the size recommendation further comprises comparing at least one predicted fit assessment for the at least one size with at least one fit assessment determining an appropriate fit of apparels of at least the same style and type to any individual.

15) The method of claim 12 wherein the step of comparing the sets of fit assessments further comprises comparing magnitudes of fit assessments.

16) The method of claim 12 wherein the step of comparing the sets of fit assessments further comprises determining functional interrelations between fit assessments.

17) The method of claim 12 wherein the step of comparing the sets of fit assessments further comprises determining similarities between fit assessments.

18) The method of claim 12 wherein the step of providing the size recommendation is further based on at least one integral predicted fit assessment generated from a plurality of the predicted fit assessments.

19) The method of claim 12 wherein the step of comparing the sets of fit assessments comprises the substeps of:
e1) supplementing the defined subset by the at least one record associated with the selected individual;
e2) locating, in the supplemented subset, overlap pairs of groups of sets of fit assessments wherein at least one set of fit assessments associated with the selected individual contributes to at least one overlap pair of groups, and wherein each group comprises those sets of fit assessments associated with a single individual, and wherein sets of fit assessments within each group are related to different sizes and designations; and
e3) comparing the sets of fit assessments for the located overlap pairs.

20) The method of claim 12 wherein the step of comparing the sets of fit assessments comprises the substeps of:
e1) supplementing the defined subset by the at least one record associated with the selected individual;
e2) locating in the supplemented subset overlap pairs of sets of fit assessments related to matching sizes and designations wherein each overlap pair comprises fit assessments associated with two different individuals, and wherein at least one of the overlap pairs comprises fit assessments associated with the selected individual;
e3) comparing the sets of fit assessments for the located overlap pairs.

21) The method of claim 12 wherein the step of comparing the sets of fit assessments further comprises comparing at least one set of fit assessments from the at least one record associated with the selected individual with at least one set of fit assessments from the defined subset.

22) The method of claim 12 wherein the step of comparing the sets of fit assessments further comprises comparing at least one set of fit assessments from the defined subset with another set of fit assessments from the defined subset.

23) The method of claim 12 wherein the step of comparing the sets of fit assessments comprises the substeps of: comparing at least one set of fit assessments from the defined subset with another set of fit assessments from the defined subset to generate at least one additional set of fit assessments; and comparing the at least one additional set of fit assessments with the at least one record associated with the selected individual.

24) The method of claim 12 wherein the step of comparing the sets of fit assessments comprises directly comparing fit assessments from different sets thereof.

25) The method of claim 12 wherein the step of comparing the sets of fit assessments comprises comparing different sets of fit assessments respectively associated with different sizes of the selected article of apparel.

26) The method of claim 12 wherein the step of comparing the sets of fit assessments comprises comparing sets of fit assessments respectively associated with different designations.

27) The method of claim 12 wherein the step of comparing the sets of fit assessments comprises the substeps of:
e1) supplementing the defined subset by the at least one record associated with the selected individual;
e2) locating, in the supplemented subset, overlap pairs of groups of sets of fit assessments wherein at least one set of fit assessments associated with the selected individual contributes to at least one overlap pair of groups, and wherein each group comprises those sets of fit assessments related to a single size and designation and wherein sets of fit assessments within each group are associated with different individuals; and
e3) comparing the sets of fit assessments for the located overlap pairs.

28) The method of claim 12 wherein the step of comparing the sets of fit assessments comprises the substeps of:
e1) supplementing the defined subset by the at least one record associated with the selected individual;
e2) locating, in the supplemented subset, overlap pairs of sets of fit assessments having different sizes and designations for the associated individual wherein at least one set of fit assessments associated with the selected individual contributes to at least one overlap pair; and
e3) comparing the sets of fit assessments for the located overlap pairs.

29) The method of claim 12 wherein the step of comparing the sets of fit assessments comprises comparing at least one set of fit assessments associated with the selected individual with at least one other set of fit assessments associated with the selected individual.

30) The method of claim 12 wherein the step of comparing the sets of fit assessments further comprises comparing at least one set of fit assessments from the defined subset with another set of fit assessments from the defined subset wherein the compared sets are associated with the same individual.

31) The method of claim 12 wherein the step of comparing the sets of fit assessments further comprises comparing at least one set of fit assessments from the defined subset with another set of fit assessments from the defined subset to generate at least one additional set of fit assessments; and comparing the at least one additional set of fit assessments with the at least one record related to the selected article of apparel.

32) The method of claim 12 wherein the step of comparing the sets of fit assessments comprises comparing different sets of fit assessments respectively associated with the same size.

33) The method of claim 12 wherein the step of comparing the sets of fit assessments comprises comparing sets of fit assessments respectively associated with the same designation.

34) The method of claim 12 wherein the step of comparing the sets of fit assessments comprises the substeps of:
e1) supplementing the defined subset by the at least one record associated with the selected individual;
e2) locating, in the supplemented subset, first overlap pairs of sets of fit assessments related to matching sizes and designations wherein each overlap pair comprises fit assessments associated with two different individuals, and wherein at least one of the overlap pairs comprises fit assessments associated with the selected individual;
e3) locating, in the supplemented subset, second overlap pairs of sets of fit assessments wherein each overlap pair comprises fit assessments associated with articles of apparel having different sizes and designations, wherein all the fit assessments in each overlap pair are associated with the same individual, and wherein at least one overlap pair comprises sets of fit assessments associated with the selected individual; and
e4) comparing the sets of fit assessments from the first and the second overlap pairs of sets thereof.

35) The method of claim 12 wherein the step of comparing the sets of fit assessments comprises comparing different sets of fit assessments, at least two of the compared sets of fit assessments being related to the same size and designation and at least two being associated with the same individual.

36) A method of providing for a selected individual at least one size recommendation for a selected article of apparel, the method comprising the steps of:
a) providing a reference set of records, each record in the set comprising an associated individual's identity, a respective designation for a respective article of apparel, an associated size of the respective article of apparel and an associated fit assessment comprising a respective value assigned to the respective article of apparel;
b) receiving a designation of the selected article of apparel;
c) receiving at least one record associated with the selected individual, each record associated with the selected individual comprising a respective designation for a respective article of apparel of at least the same style and type as the selected article of apparel, an associated size of the respective article of apparel and an associated fit assessment comprising a respective value assigned to the respective article of apparel;
d) providing a set of produced sizes of the selected article of apparel;
e) defining a set of missing sizes of the selected article of apparel, the set of missing sizes including all sizes in the at least one record associated with the selected individual for which there is no corresponding fit assessment;
f) providing at least one rule of changes of characteristics and fit assessments between sizes of the selected article of apparel for at least some of the sizes in the set of produced sizes;
g) predicting at least one fit assessment related to at least one size from the defined set of missing sizes based on at least one respective fit assessment from the at least one record associated with the selected individual and on the at least one rule of changes; and
h) providing the at least one size recommendation based on the at least one predicted fit assessment related to at least one size from the defined set of missing sizes.
